(19) United States
(12) Patent Application Publication
(10) Pub. No.: US 2015/0253426 A1
(43) Pub. Date: Sep. 10, 2015

(54) LASER RADAR DEVICE AND OBJECT DETECTING METHOD

(71) Applicant: Hideyuki Yasugi, Aichi (JP)

(72) Inventor: Hideyuki Yasugi, Aichi (JP)

(73) Assignee: OMRON AUTOMOTIVE ELECTRONICS CO., LTD., Aichi (JP)

(21) Appl. No.: 14/630,875

(22) Filed: Feb. 25, 2015

(30) Foreign Application Priority Data
Mar. 7, 2014 (JP) 2014-044637

(51) Int. Cl. G01S 17/08; G01S 7/486; G01S 17/02

(52) U.S. Cl. CPC G01S 17/08; G01S 17/026; G01S 7/4861

(57) ABSTRACT

A laser radar device disclosed herein includes a projector configured to project a laser beam to a predetermined monitoring area, a vertical direction beam receiver configured to receive reflected beam of the laser beam, the vertical direction beam receiver including predetermined numbers of dead zones and sensing zones disposed alternately in a vertical direction, and including in the vertical direction a plurality of resolutions configured, a peak detector configured to detect a peak of a received beam level of each of the reflected beams received by the sensing zones, and an object detector configured to calculate a distance to an object per sensing zone using the peak. The object detector recognizes that the object having a predetermined height is detected when continuously recognizing the distance calculated per sensing zone as the same distance for a predetermined number of times or more.

### CROSS-REFERENCE TO RELATED APPLICATION

This application is based on Japanese Patent Application No. 2014-044637 filed with the Japan Patent Office on Mar. 7, 2014, the entire contents of which are incorporated herein by reference.

### FIELD

The disclosure relates to a laser radar device and an object detecting method. More particularly, the disclosure relates to a laser radar device and an object detecting method which improve object detection precision.

### BACKGROUND

Conventionally, a technique of improving detection precision of a laser radar device which projects measurement beams which are pulsed laser beams, to a predetermined monitoring area and has a plurality of beam receiving elements simultaneously receiving reflected beams from a plurality of directions has been proposed.

A technique of accurately calculating a distance to a leading vehicle by, for example, irradiating a monitoring area with laser beams which widely spread in a vertical direction while changing horizontal direction angles of the laser beams, calculating a size of a detection object based on a range of each sweep angle at which reflected beams are detected, selecting the detection object in a size range of vehicle reflex reflectors and thereby distinguishing the leading vehicle from other signboards has been proposed (see, for example, Japanese Patent Application Laid-Open No. 6-148329).

By the way, according to Japanese Patent Application Laid-Open No. 6-148329, whether or not there is a leading vehicle is determined based on sizes of reflectors calculated based on horizontal direction angles and distances. Therefore, there is a problem that, when sizes of road studs buried in a road are the same as a vehicle in the horizontal direction, the road studs are erroneously determined as vehicles.

### SUMMARY

One or more embodiments of the disclosure improve detection precision by preventing objects such as road studs which are not likely to collide with a relevant vehicle and are provided to slopes and roads from being erroneously detected as objects which are likely to cause collision when projecting laser beams to a monitoring area, receiving reflected beams and detecting obstacles in the monitoring area.

A laser radar device according to one or more embodiments of the disclosure include:

a projector configured to project a laser beam to a predetermined monitoring area;

a vertical direction beam receiver configured to receive reflected beam of the laser beam, the vertical direction beam receiver including predetermined numbers of dead zones and sensing zones disposed alternately in a vertical direction, and including in the vertical direction a plurality of resolutions;

a peak detector configured to detect a peak of a received beam level of each of the reflected beams received by the sensing zones; and

an object detector configured to calculate a distance to an object per sensing zone using the peak, and

the object detector recognizes that the object including a predetermined height is detected when continuously recognizing the distance calculated per sensing zone as the same distance for a predetermined number of times or more.

According to this configuration, it is possible to detect whether or not there are objects which are obstacle candidates, based on information of the distance of the object. Further, the vertical direction distances of a plurality of resolutions which detects the object are detected. Consequently, when objects which are obstacle candidates are detected, it is possible to specify whether the detected objects which are obstacle candidates are slopes, road studs or objects such as human bodies having lengths in a height direction.

The dead zones and the sensing zones may be located at the same positions or different positions in a horizontal direction.

According to this configuration, as long as the dead zones and the sensing zones are disposed alternately in the vertical direction, the dead zones and the sensing zones may be located at the same positions or different positions in the horizontal direction. When the dead zones and the sensing zones are disposed alternately in the vertical direction at all times, even if an object such as a road stud which includes a reflector and which is not likely to cause collision is detected on a road surface, information of the horizontal direction and a distance of the detected object is not outputted. Consequently, it is possible to prevent erroneous detection.

The dead zones may be configured as the sensing zones, and may function as the dead zones by causing the sensing zones not to function.

According to this configuration, even when only the sensing zones are provided, the dead zones and the sensing zones can be provided alternately in the vertical direction by, for example, causing software to set portions with which the sensing zones are provided alternately in the vertical direction and which do not function as the sensing zones. Consequently, even if an object such as a road stud which includes a reflector and which is not likely to cause collision is detected on a road surface, information of the horizontal direction and a distance of the detected object is not outputted. Consequently, it is possible to prevent erroneous detection.

An object detecting method according to the present technique includes the steps of:

projecting a laser beam to a predetermined monitoring area;

receiving reflected beam of the laser beam at a vertical direction beam receiver including predetermined numbers of dead zones and sensing zones disposed alternately in a vertical direction and including a plurality of resolutions in the vertical direction;

detecting a peak of a received beam level of each of the reflected beams received by the sensing zones; and

calculating a distance to an object per sensing zone using the peak, and

it is recognized that the object including a predetermined height is detected when the distance calculated per sensing zone is continuously recognized as the same distance for a predetermined number of times or more.

This projecting step is executed by, for example, a drive circuit, a light emitting element, a projecting optical system or the like. This beam receiving step is executed by, for example, a beam receiving optical system, beam receiving elements or the like. This peak detecting step and the object detecting step are executed by, for example, computing devices such as microcomputers and various types of processors.

According to one or more embodiments of the disclosure, laser beams are projected to a predetermined monitoring area. Further, when the vertical direction beam receiver which includes the predetermined numbers of dead zones and sensing zones disposed alternately in the vertical direction includes a plurality of resolutions in the vertical direction to receive beams, a peak of the received beam level of each reflected beam received by the sensing zones is detected. Furthermore, a distance to the object is calculated per sensing zone using the peak. Still further, when the distance calculated per sensing zone can be continuously recognized as the same for a predetermined number of times or more, it is recognized that the object having a predetermined height is detected.

According to one or more embodiments of the disclosure, it is possible to prevent erroneous detection such as an output of information of a distance of an object which is not concerned to cause collision, and to improve object detection precision.

### BRIEF DESCRIPTION OF THE DRAWINGS

FIG. 1 is a block diagram illustrating one or more embodiments of a laser radar device to which the disclosure is applied;

FIG. 2 is a front view of the laser radar device;

FIG. 3 is a view for explaining a measurement principle of the laser radar device;

FIG. 4 is a block diagram illustrating a configuration example of a projector;

FIG. 5 is a block diagram illustrating a configuration example of a beam receiver;

FIG. 6 is a block diagram illustrating a configuration example of a measurer;

FIG. 7 is a schematic view illustrating a configuration example of a multiplexer function;

FIG. 8 is a block diagram illustrating a configuration example of an arithmetic operator function;

FIG. 9 is a flowchart for explaining object detection processing;

FIG. 10 is a timing chart for explaining the object detection processing;

FIG. 11 is a view for explaining processing of integrating received beam values;

FIG. 12 is a view illustrating a combination example of beam receiving elements allocated in each measurement period;

FIG. 13 is a view for explaining an example of a method of detecting a vehicle in a horizontal direction;

FIG. 14 is a view for explaining an example where a vehicle is erroneously detected;

FIG. 15 is a view for explaining an example of detection in a vertical direction;

FIG. 16 is a view for explaining an example of detection in the vertical direction;

FIG. 17 is a view for explaining an example where erroneous detection is prevented in the vertical direction;

FIG. 18 is a view for explaining an example where erroneous detection is prevented in the vertical direction;

FIG. 19 is a view illustrating a modified example of the projector and a beam receiver;

FIG. 20 is a view illustrating a modified example of the projector and the beam receiver;

FIG. 21 is a view for explaining an example of a detecting method when no dead zone is provided to the beam receiver;

FIG. 22 is a view for explaining an example of the detecting method when no dead zone is provided to the beam receiver; and

FIG. 23 is a block diagram illustrating a configuration example of a computer.

### DETAILED DESCRIPTION

Embodiments of the disclosure (referred to as an embodiment below) will be described below. In embodiments of the disclosure, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. In addition, the description is given in the following order

1. Embodiments

2. Modified Example

### 1. Embodiments

### Configuration Example of Laser Radar Device 11

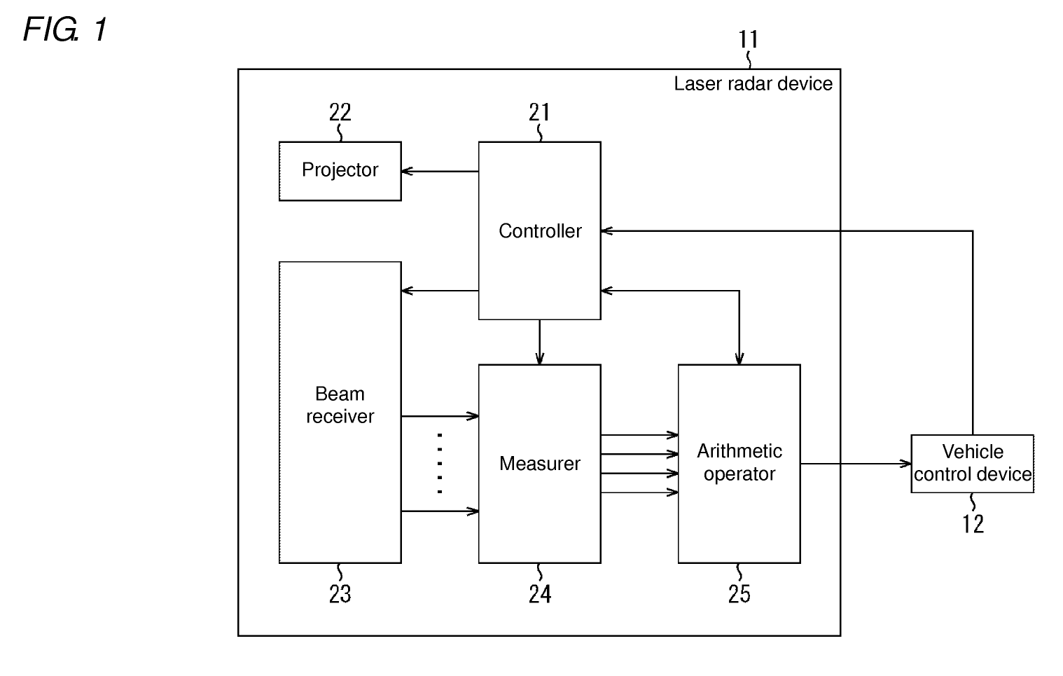

FIG. 1 illustrates a configuration example of a laser radar device 11 which is one or more embodiments of the laser radar device to which the disclosure is applied.

The laser radar device 11 is provided at, for example, an upper portion inside a front glass of a vehicle, and detects an object in a traveling direction of this vehicle. In addition, an area in which the laser radar device 11 can detect an object will be referred to as a monitoring area below. Further, the vehicle provided with the laser radar device 11 will be referred to as a relevant vehicle if it is necessary to distinguish from other vehicles. Furthermore, a direction parallel to a left and right direction (vehicle width direction) of the relevant vehicle will be referred to as a horizontal direction.

The laser radar device 11 employs a configuration including a controller 21, a projector 22, a beam receiver 23, a measurer 24 and an arithmetic operator 25.

The controller 21 controls each unit of the laser radar device 11 based on an instruction, information and the like from a vehicle control device 12.

The projector 22 projects measurement beams which are pulsed laser beams (laser pulses) used to detect an object, to a monitoring area.

The beam receiver 23 receives reflected beams of measurement beams, and detects intensities (luminances) of the reflected beams from different directions of the horizontal direction and the vertical direction. Further, the beam receiver 23 outputs a plurality of received beam signals which is electrical signals corresponding to the intensities of the reflected beams in each direction.

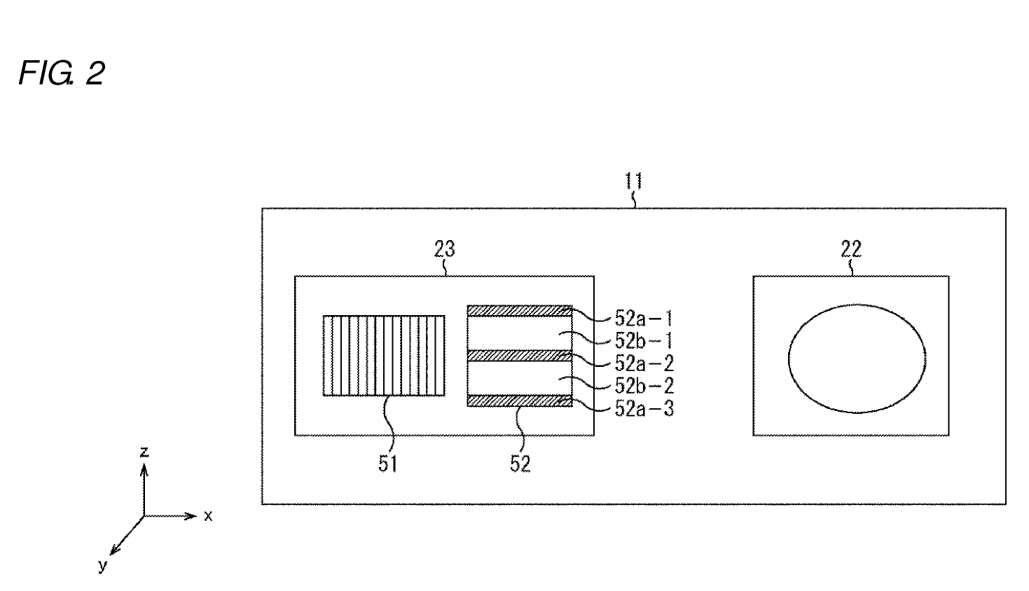

More specifically, the projector 22 and the beam receiver 23 are configured as illustrated in, for example, FIG. 2. In addition, FIG. 2 is a front view of the laser radar device 11 which includes the projector 22 and the beam receiver 23 in the front. The projector 22 is provided on the right in FIG. 2, and the beam receiver 23 is provided on the left.

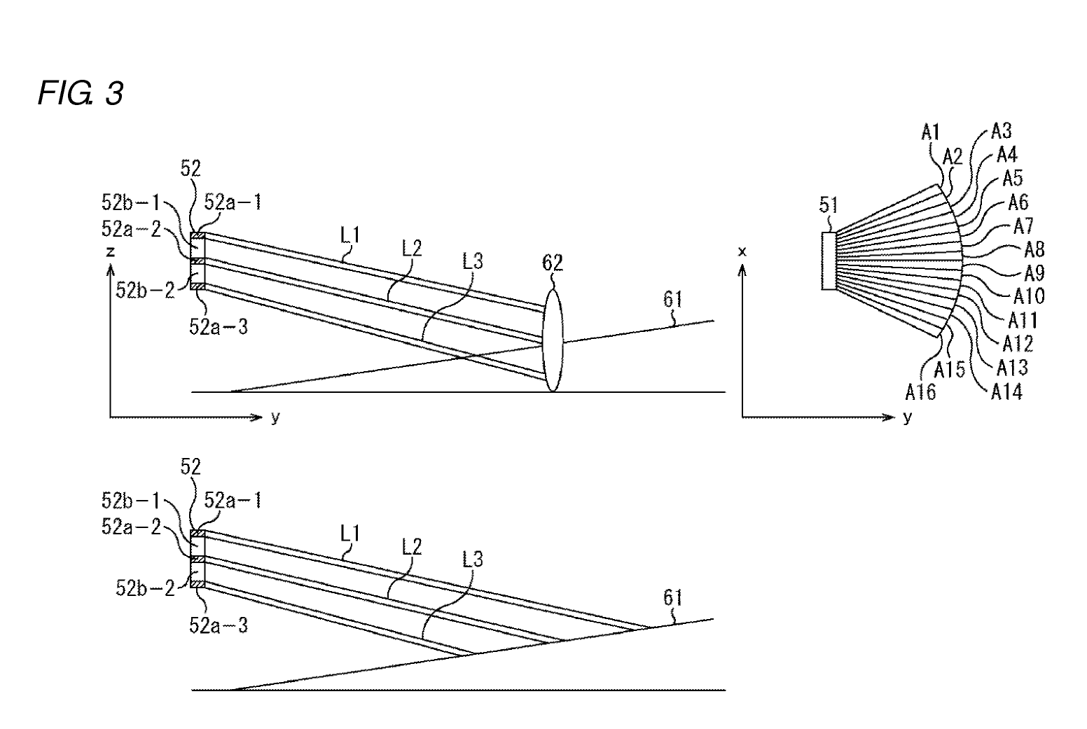

The beam receiver 23 is provided with a horizontal direction beam receiver 51 and a vertical direction beam receiver 52. The horizontal direction beam receiver 51 detects intensities of reflected beams which are beams reflected from an object in a monitoring area and are reflected from different directions of the horizontal direction among reflected beams of measurement beams projected by the projector 22, and outputs the intensities as received beam signals. More specifically, as illustrated on the right portion in FIG. 3, the horizontal direction beam receiver 51 detects intensities of reflected beams reflected from an object per two-dimensional detection area which is defined by XY axes seen from the top view.

The vertical direction beam receiver 52 detects intensities of reflected beams which are beams reflected from the object in the monitoring area and are reflected from three different directions of the vertical direction among the reflected beams of the measurement beams projected by the projector 22, and outputs the intensities as received beam signals. More specifically, as illustrated at the upper left portion in FIG. 3, the vertical direction beam receiver 52 has sensing zones 52a-1 to 52a-3 at which beam receiving elements are located, and dead zones 52b-1 and 52b-2. Further, as illustrated at the upper left portion in FIG. 3, the sensing zones 52a-1 to 52a-3 are located alternately in the vertical direction sandwiching the dead zones 52b-1 and 52b-2. By this means, the sensing zones 52a-1 to 52a-3 detect the intensities of the reflected beams reflected from the object of three types of heights in the two-dimensional vertical direction indicated by YZ axes.

In addition, when the sensing zones 52a-1 to 52a-3 and the dead zones 52b-1 and 52b-2 will be referred to simply as the sensing zone 52a and the dead zone 52b below if it is unnecessary to distinguish in particular, and the other components will be referred to likewise.

The dead zones 52b-1 and 52b-2 and the sensing zones 52a-1 to 52a-3 are disposed in this way. Therefore, as illustrated at, for example, the upper left portion in FIG. 3, the laser radar device 11 receives reflected beams L1 to L3 from an object 62 having a predetermined height or more, and determines that each distance calculated with respect to the object 62 based on each reflected beam is nearly equal. Consequently, it is possible to recognize the object 62 having a height which is concerned to collide with the relevant vehicle.

Meanwhile, as illustrated at the lower left portion in FIG. 3, when there is not the object 62, different distances are detected from the reflected beams L1 to L3 from a slope 61. Consequently, it is possible to recognize the slope 61, and to recognize that there is no concern of collision with the relevant vehicle.

Further, laser beams projected by the projector 22 disperse in the horizontal direction and the vertical direction. Therefore, the laser beams to be projected in a higher vertical direction are projected to disperse farther in a wider range. Similarly, a detection area in a higher vertical direction is farther and is a wider range in the horizontal direction.

Back to explanation of FIG. 1, the measurer 24 measures received beam values based on received beam signals supplied from the beam receiver 23, and supplies measurement results to the arithmetic operator 25.

The arithmetic operator 25 detects an object in a monitoring area based on the measurement results of the received beam values supplied from the measurer 24, and supplies a detection result to the controller 21 and the vehicle control device 12.

The vehicle control device 12 is made up by, for example, an ECU (Electronic control unit), and performs automatic brake control or issues a warning to a driver based on a detection result of an object in a monitoring area.

### Configuration Example of Projector 22

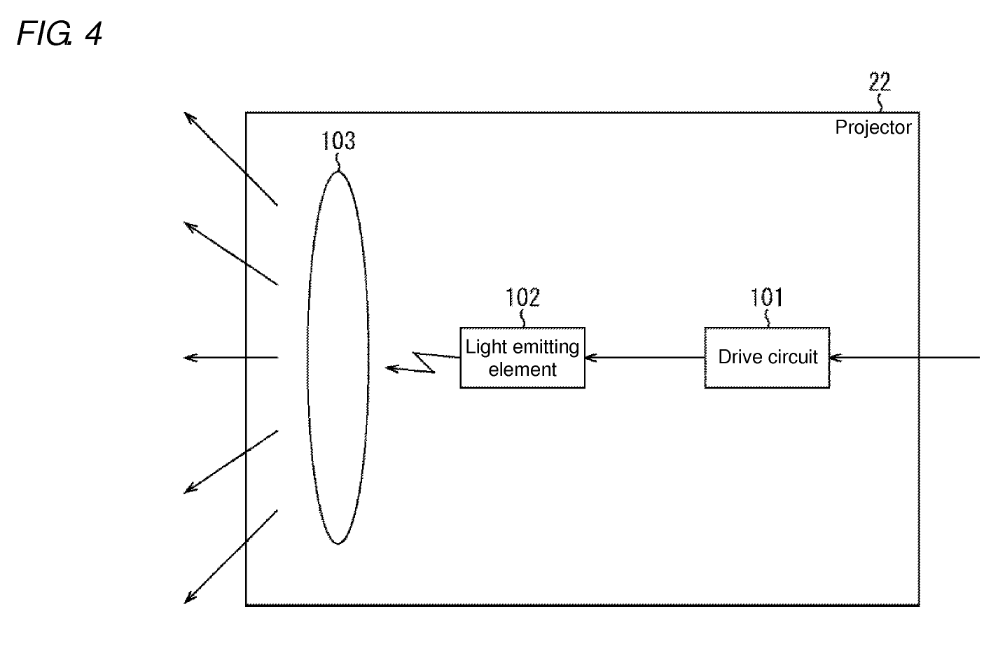

FIG. 4 illustrates a configuration example of the projector 22 of the laser radar device 11. The projector 22 employs a configuration including a drive circuit 101, a light emitting element 102 and a projecting optical system 103.

Under control of the controller 21, the drive circuit 101 controls a light emission intensity, a light emission timing and the like of the light emitting element 102.

The light emitting element 102 is made up by, for example, a laser diode, and emits measurement beams (laser pulses) under control of the drive circuit 101. The measurement beams emitted from the light emitting element 102 are projected to a monitoring area through the projecting optical system 103 formed by a lens or the like.

### Configuration Example of Beam Receiver 23

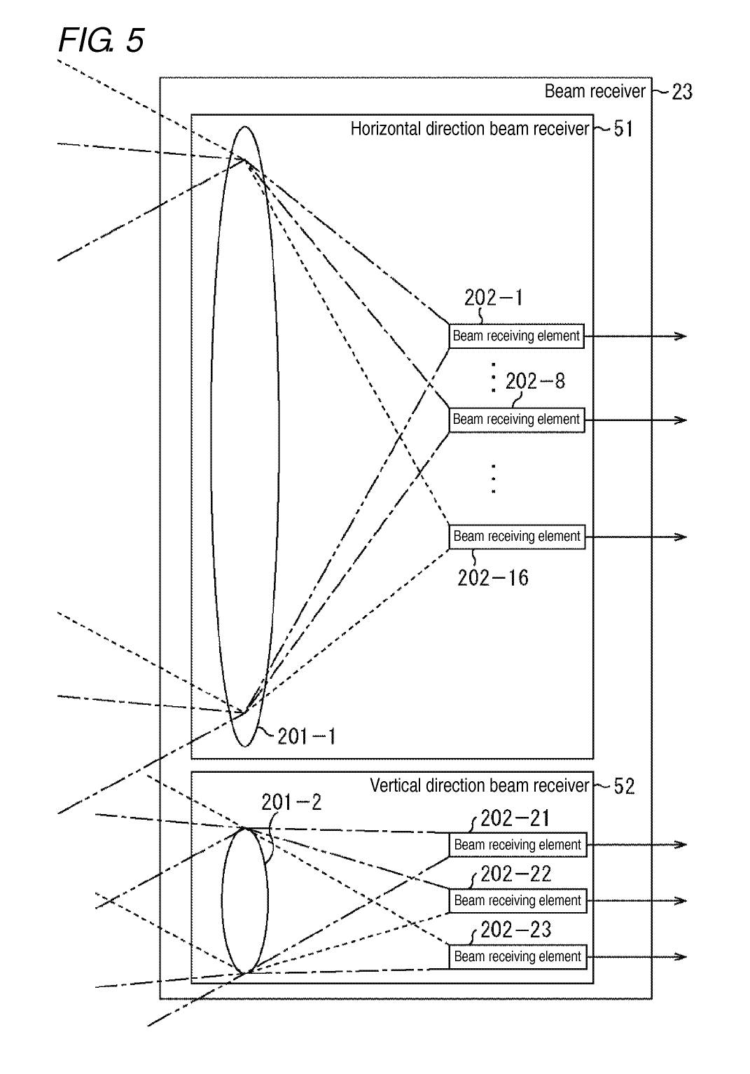

FIG. 5 illustrates a configuration example of the beam receiver 23 of the laser radar device 11. The horizontal direction beam receiver 51 of the beam receiver 23 employs a configuration including a beam receiving optical system 201-1 and beam receiving elements 202-1 to 202-16.

The beam receiving optical system 201-1 is formed by a lens or the like, and is installed such that an optical axis is oriented toward a longitudinal direction of the vehicle. Further, reflected beams of measurement beams reflected from an object or the like in a monitoring area are incident on the beam receiving optical system 201-1. Furthermore, the beam receiving optical system 201-1 has the incident reflected beams incident on a beam receiving surface of each beam receiving element 202.

Each of the beam receiving elements 202-1 to 202-16 is, for example, a photodiode which photoelectrically converts an incident photocharge into a received beam signal of a current value corresponding to a beam amount of the photocharge. Further, each of the beam receiving elements 202-1 to 202-16 is provided to align in a row vertically with respect to the optical axis of the beam receiving optical system 201-1 and in parallel to the vehicle width direction of the relevant vehicle (i.e., the horizontal direction) at positions at which reflected beams having been incident on the beam receiving optical system 201-1 condense. Furthermore, the reflected beams having been incident on the beam receiving optical system 201-1 are sorted to and incident on each of the beam receiving elements 202-1 to 202-16 according to horizontal direction incident angles with respect to the beam receiving optical system 201-1. Hence, each of the beam receiving elements 202-1 to 202-16 receives reflected beams from different directions of the horizontal direction among the reflected beams from the monitoring area. By this means, the monitoring area is divided into a plurality of areas (referred to as detection areas below) in a plurality of directions in the horizontal direction. Further, each of the beam receiving elements 202-1 to 202-16 individually receives reflected beams from corresponding detection areas. Furthermore, the beam receiving elements 202-1 to 202-16 photoelectrically convert the received reflected beams into received beam signals of current values corresponding to received beam amounts of the reflected beams, and supplies the resulting received beam signals to the measurer 24.

The vertical direction beam receiver 52 of the beam receiver 23 employs a configuration including a beam receiving optical system 201-2 and beam receiving elements 202-21 to 202-23.

The beam receiving optical system 201-2 is formed by a lens or the like, and is installed such that an optical axis is oriented toward a longitudinal direction of the vehicle. Further, reflected beams of measurement beams reflected from an object or the like in a monitoring area are incident on the beam receiving optical system 201-2. Furthermore, the beam receiving optical system 201-2 has the incident reflected beams incident on a beam receiving surface of each beam receiving element 202.

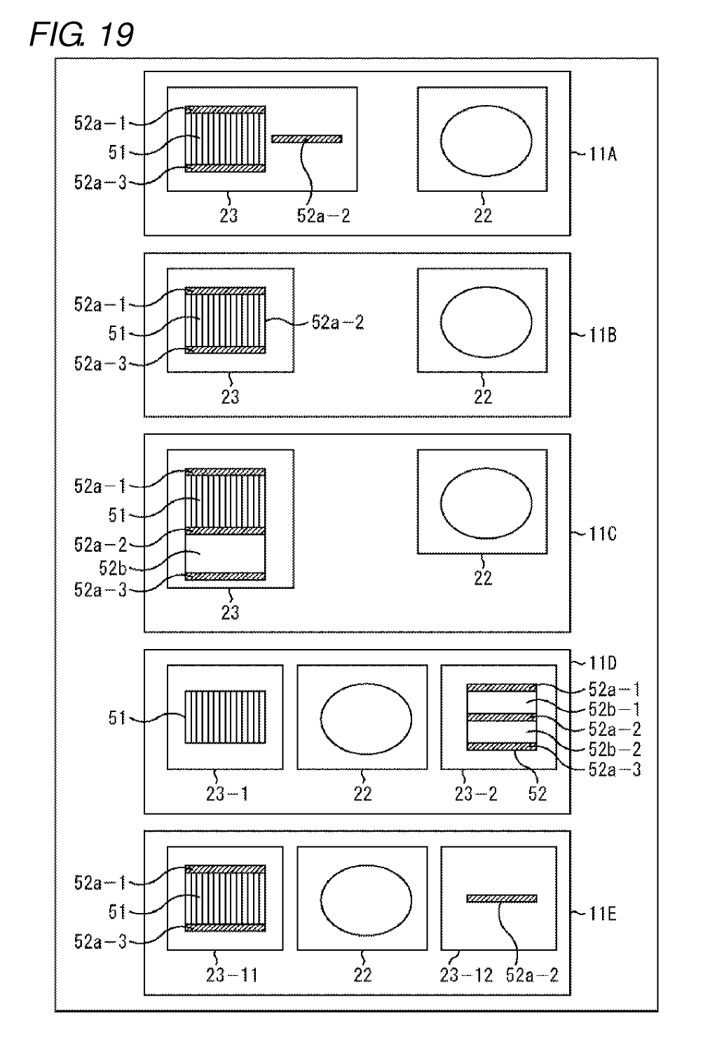

Each of the beam receiving elements 202-21 to 202-23 is provided to align in a row vertically with respect to the optical axis of the beam receiving optical system 201-2 and in parallel to the vehicle height direction of the relevant vehicle (i.e., the vertical direction) at positions at which reflected beams having been incident on the beam receiving optical system 201-2 condense. Further, only the incident beams which are incident on the beam receiving optical system 201-2 at predetermined incident angles in the vertical direction of the reflected beams having been incident on the beam receiving optical system 201-2 are sorted to and incident on each of the beam receiving elements 202-21 to 202-23. Hence, each of the beam receiving elements 202-21 to 202-23 receives reflected beams from three directions corresponding to incident angles of the sensing zones 52a-1 to 52a-3 (FIG. 19) in the vertical direction among the reflected beams from the monitoring area.

Further, the beams which are incident on the beam receiving optical system 201-2 of the sensing zones 52a-1 to 52a-3 are emitted at different angles according to the incident angles in the vertical direction. Therefore, only the incident beams from predetermined directions are incident on each of the beam receiving elements 202-21 to 202-23. Hence, the sensing zones 52a-1 to 52a-3 receive reflected beams from one predetermined direction in the vertical direction among the reflected beams from the monitoring area. Therefore, the vertical direction beam receiver 52 receives reflected beams from three directions. Furthermore, the beam receiving elements 202-21 to 202-23 photoelectrically convert the received reflected beams into received beam signals of current values corresponding to received beam amounts of the reflected beams, and supply the resulting received beam signals to the measurer 24. That is, in this example, resolutions of three directions are provided in the vertical direction, and only whether or not reflected beams from three predetermined directions corresponding to the sensing zones 52a set sandwiching the dead zones 52b are received is detected.

Further, in this example, the dead zone 52b employs a configuration without the beam receiving element 202. However, the dead zone 52b may be provided with the beam receiving element 202. In this case, a received beam signal from the beam receiving element 202 belonging to the dead zone 52b may be discarded or a received beam signal may not be outputted.

In addition, the number of the horizontal direction resolutions is 16 directions. However, the number of resolutions may be a number of directions other than the 16 directions. Further, similarly, the number of the vertical direction resolutions may be a number of directions other than the three directions.

### Configuration Example of Measurer 24

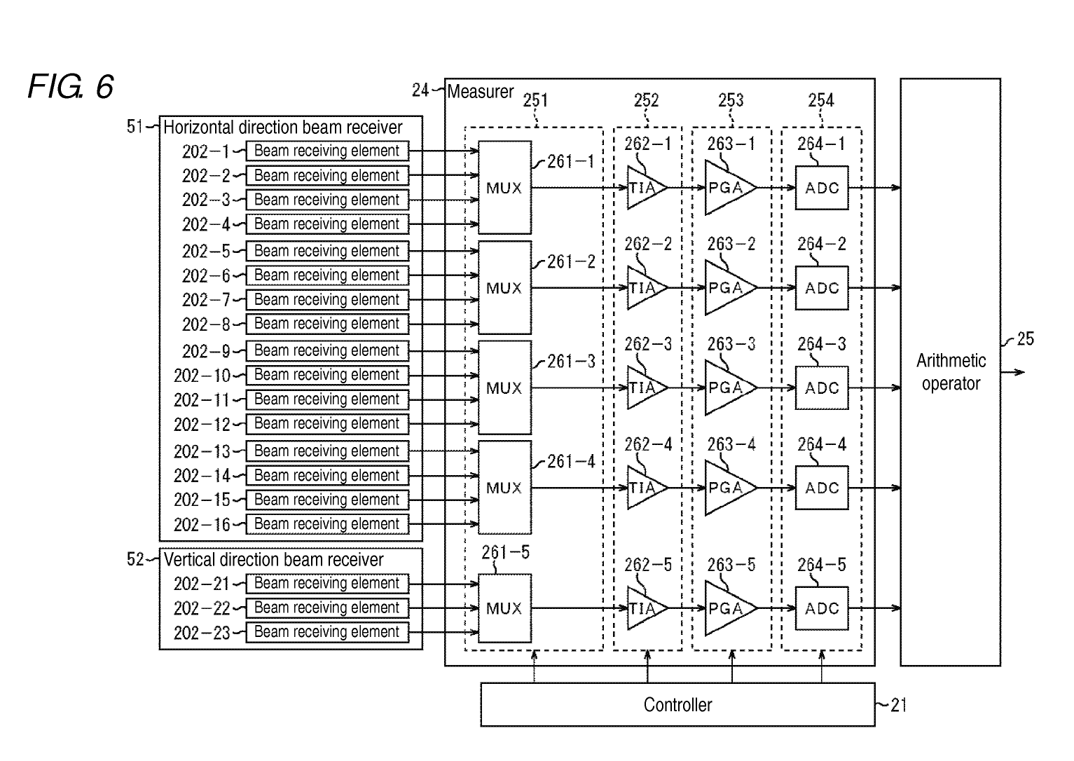

FIG. 6 illustrates a configuration example of the measurer 24 of the laser radar device 11. The measurer 24 employs a configuration including a selector 251, a current/voltage converter 252, an amplifier 253 and a sampler 254. The selector 251 employs a configuration including multiplexers (MUX) 261-1 to 261-5. The current/voltage converter 252 employs a configuration including transimpedance amplifiers (TIA) 262-1 to 262-5. The amplifier 253 employs a configuration including programmable gain amplifiers (PGA) 263-1 to 263-5. The sampler 254 employs a configuration including A/D converters (ADC) 264-1 to 264-5.

In addition, the MUXs 261-1 to 261-5, the TIAs 262-1 to 262-5, the PGAs 263-1 to 263-5 and the ADCs 264-1 to 264-5 will be referred simply to as the MUXs 261, the TIAs 262, the PGAs 263 and the ADCs 264, respectively, if it is unnecessary to individually distinguish.

Under control of the controller 21, the MUX 261-1 selects one or more received beam signals supplied from the beam receiving elements 202-1 to 202-4, and supplies the received beam signals to the TIA 262-1. In addition, when selecting a plurality of received beam signals, the MUX 261-1 adds the selected received beam signals, and supplies the received beam signal to the TIA 262-1.

Under control of the controller 21, the MUX 261-2 selects one or more received beam signals supplied from the beam receiving elements 202-5 to 202-8, and supplies the received beam signals to the TIA 262-2. In addition, when selecting a plurality of received beam signals, the MUX 261-2 adds the selected received beam signals, and supplies the received beam signal to the TIA 262-2.

Under control of the controller 21, the MUX 261-3 selects one or more received beam signals supplied from the beam receiving elements 202-9 to 202-12, and supplies the received beam signals to the TIA 262-3. In addition, when selecting a plurality of received beam signals, the MUX 261-3 adds the selected received beam signals, and supplies the received beam signal to the TIA 262-3.

Under control of the controller 21, the MUX 261-4 selects one or more received beam signals supplied from the beam receiving elements 202-13 to 202-16, and supplies the received beam signals to the TIA 262-4. In addition, when selecting a plurality of received beam signals, the MUX 261-4 adds the selected received beam signals, and supplies the received beam signal to the TIA 262-4.

Under control of the controller 21, the MUX 261-5 selects one or more received beam signals supplied from the beam receiving elements 202-21 to 202-23, and supplies the received beam signals to the TIA 262-5. In addition, when selecting a plurality of received beam signals, the MUX 261-5 adds the selected received beam signals, and supplies the received beam signal to the TIA 262-1. In this regard, although the MUX 261-5 can functionally select a plurality of received beam signals, the MUX 261-5 selects one of directions in the vertical direction in this regard.

Hence, the beam receiving elements 202 are divided into a first group including the beam receiving elements 202-1 to 202-4 in the horizontal direction beam receiver 51, a second group including the beam receiving elements 202-5 to 202-8, a third group including the beam receiving elements 202-9 to 202-12, a fourth group including the beam receiving elements 202-13 to 202-16, and a group including the beam receiving elements 202-21 to 202-23 in the vertical direction beam receiver 52. Further, the MUX 261-1 selects the beam receiving element 202 of the first group, and outputs a received beam signal of the selected beam receiving element 202. The MUX 261-2 selects the beam receiving element 202 of the second group, and outputs a received beam signal of the selected beam receiving element 202. The MUX 261-3 selects the beam receiving element 202 of the third group, and outputs a received beam signal of the selected beam receiving element 202. The MUX 261-4 selects the beam receiving element 202 of the fourth group, and outputs a received beam signal of the selected beam receiving element 202. The MUX 261-5 selects the beam receiving element 202 of the vertical direction beam receiver 52, and outputs a received beam signal of the selected beam receiving element 202.

Under control of the controller 21, each TIA 262 converts a current of the received beam signal supplied from the MUX 261 into a voltage. That is, each TIA 262 converts the received beam signal of an inputted current, into a received beam signal of a voltage, and amplifies the voltage of the converted received beam signal at a gain set by the controller 21. Further, each TIA 262 supplies the amplified received beam signal to the PGA 263 of a subsequent stage.

Under control of the controller 21, each PGA 263 amplifies the voltage of the received beam signal supplied from the TIA 262 at the gain set by the controller 21, and supplies the gain to the ADC 264 of a subsequent stage.

Each ADC 264 ND-converts the received beam signal. That is, under control of the controller 21, each ADC 264 measures a received beam value by sampling an analog received beam signal supplied from the PGA 263. Further, each ADC 264 supplies a digital received beam signal indicating a sampling result (measurement result) of the received beam value, to the arithmetic operator 25.

In addition, the vertical direction beam receiving elements 202-21 to 202-23 desirably input the reflected beams to the different MUXs 261 such that the reflected beams of the same measurement beam can be simultaneously subjected to signal processing. Hence, for example, the beam receiving elements 202-21 to 202-23 may be connected to the MUXs 261-1 to 261-3, and three beam receiving elements may be simultaneously selected by the MUXs 261-1 to 261-3.

### Configuration Example of MUX 261

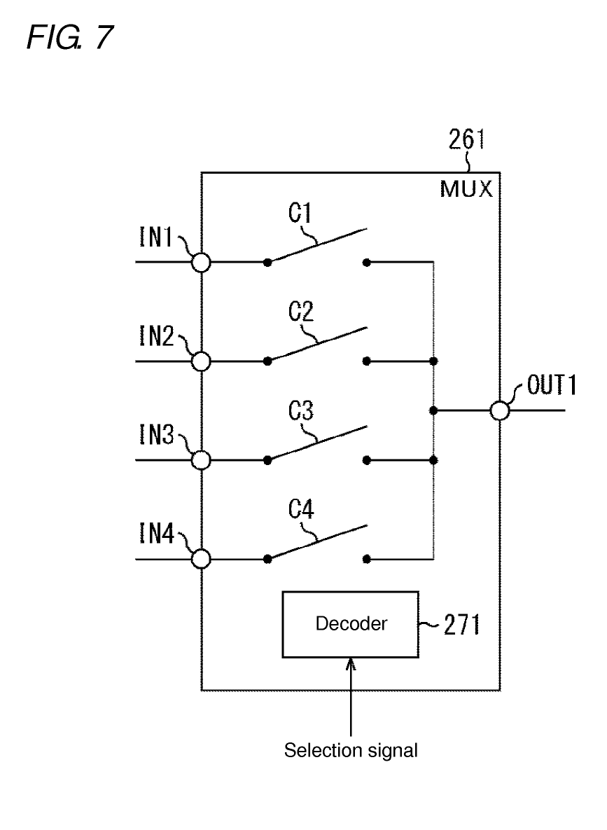

FIG. 7 schematically illustrates a configuration example of a function of the MUX 261.

The MUX 261 has a decoder 271, input terminals IN1 to 1N4, contacts C1 to C4 and an output terminal OUT1. One ends of the contacts C1 to C4 are connected to the input terminals IN1 to IN4, respectively, and the other ends of the contacts C1 to C4 are connected to the output terminal OUT 1.

In addition, the input terminals IN1 to 1N4 and the contacts C1 to C4 will be referred to simply as the input terminals IN and the contacts C below if it is unnecessary to individually distinguish.

The decoder 271 decodes a selection signal supplied from the controller 21, and individually switches between on and off of each contact C according to contents of the decoded selection signal. Further, the received beam signal inputted to the input terminal IN connected to the contact C switched to on is selected and is outputted from the output terminal OUT1. In addition, when there is a plurality of contacts C switched to on, a plurality of selected received beam signals is added and is outputted from the output terminal OUT1.

### Configuration Example of Arithmetic Operator 25

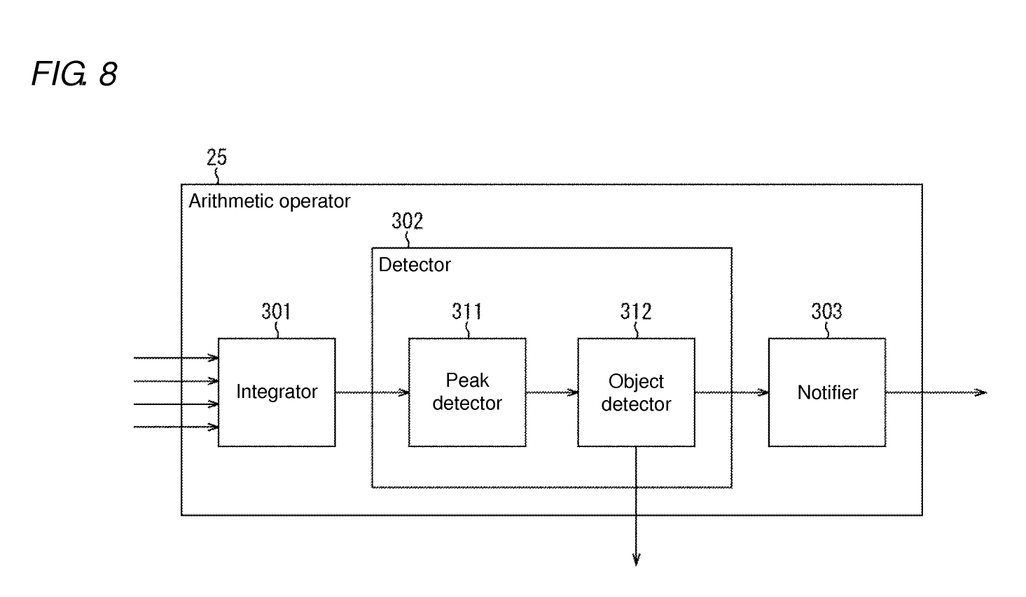

FIG. 8 illustrates a configuration example of the arithmetic operator 25.

The arithmetic operator 25 employs a configuration including an integrator 301, a detector 302 and a notifier 303. Further, the detector 302 employs a configuration including a peak detector 311 and an object detector 312.

The integrator 301 integrates received beam values of the same beam receiving element 202 per sampling time, and supplies this integration value (referred to an integrated received beam value below) to the peak detector 311.

The peak detector 311 detects horizontal direction and time direction (distance direction) peaks of intensities of reflected beams of measurement beams and vertical direction and time direction (distance direction) peaks based on the integrated received beam value (the intensity of the reflected beam) of each beam receiving element 202, and supplies a detection result to the object detector 312.

The object detector 312 detects an object in a monitoring area based on detection results of the horizontal direction and time direction (distance direction) distributions and peaks of the integrated received beam values (the intensities of the reflected beams) and the vertical direction and time direction (distance direction) distributions and peaks of the integrated received beam values, and supplies the detection result to the controller 21 and the notifier 303.

In this regard, the time direction (distance direction) peak refers to a sampling time which is a peak obtained from a distribution of integrated received beam values at a sampling time per beam receiving element 202. Consequently, a spot at which the intensity of the reflected beam comes to a peak in the distance direction from the relevant vehicle is detected per detection area. In other words, a distance to the relevant vehicle from a spot at which the intensity of a reflected beam comes to a peak is detected per detection area based on this time direction (distance direction) peak.

Further, the horizontal direction peak is a horizontal direction position which is a peak calculated from a distribution of integrated received beam values of the beam receiving elements 202 (detection area) per sampling time. Consequently, the horizontal direction position (detection area) at which the intensity of the reflected beam comes to a peak per predetermined interval (e.g. per about 1.5 m) is detected in the distance direction from the relevant vehicle.

The notifier 303 supplies the detection result of the object in the monitoring area, to the vehicle control device 12.

{Object Detection Processing}

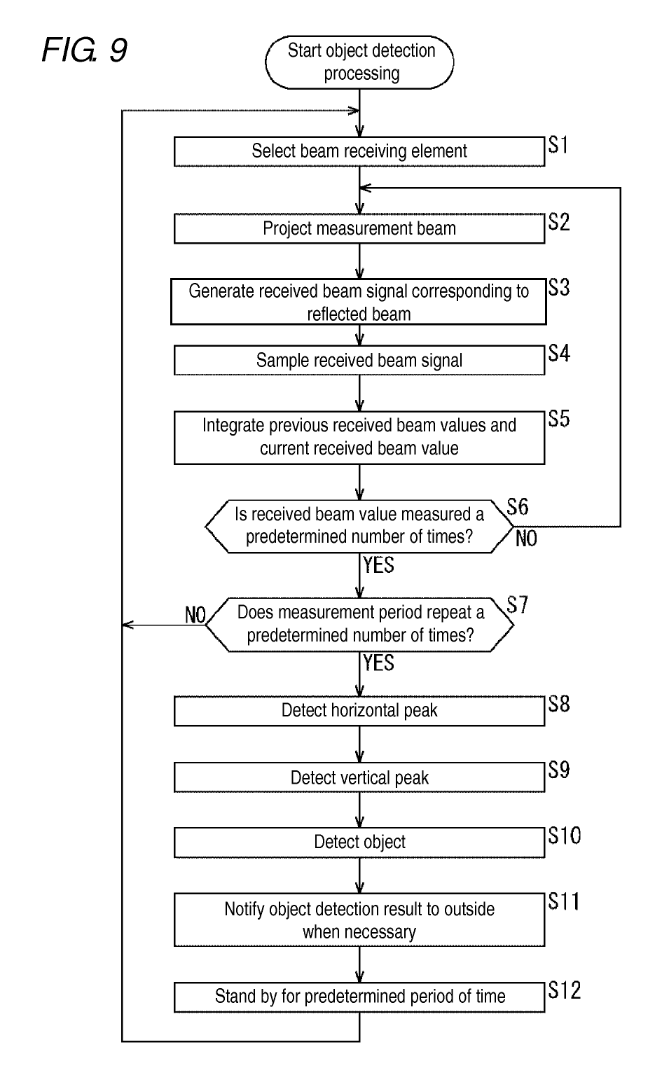

Next, the object detection processing executed by the laser radar device 11 will be described with reference to a flowchart in FIG. 9.

In step S1, each MUX 261 selects the beam receiving element 202. More specifically, under control of the controller 21, each MUX 261 selects a received beam signal to supply to the TIA 262 of a subsequent stage among received beam signals inputted to each MUX 261. Further, in the following processing, the received beam value of the beam receiving element 202 which is an output source of the selected received beam signal is measured. In other words, the intensity of the reflected beam from the detection area of the selected beam receiving element 202 is measured.

In step S2, the projector 22 projects measurement beams. More specifically, under control of the controller 21, the drive circuit 101 causes the light emitting element 102 to emit pulsed measurement beams. The measurement beams emitted from the light emitting element 102 are projected to the entire monitoring area through the projecting optical system 103.

In step S3, the beam receiver 23 generates a received beam signal corresponding to a reflected beam. More specifically, each beam receiving element 202 receives through the beam receiving optical system 201 reflected beams from the detection areas in the corresponding directions among reflected beams of the measurement beams projected in the processing in step S2. Furthermore, each beam receiving element 202 photoelectrically converts the received reflected beam into a received beam signal which is an electrical signal corresponding to the received beam amount of the reflected beam, and supplies the resulting received beam signal to the MUX 261 of a subsequent stage.

In step S4, the measurer 24 samples the received beam signal. More specifically, under control of the controller 21, each TIA 262 converts the current of the received beam signal supplied from each MUX 261 into the voltage, and amplifies the voltage of the received beam signal at a gain set by the controller 21. Each TIA 262 supplies the amplified received beam signal to the PGA 263 of a subsequent stage.

Under control of the controller 21, each PGA 263 amplifies the voltage of the received beam signal supplied from each TIA 262 at a gain set by the controller 21, and supplies the voltage to the ADC 264 of a subsequent stage.

Under control of the controller 21, each ADC 264 samples the received beam signal supplied from each PGA 263, and ND-converts the received beam signal. Each ADC 264 supplies the ND-converted received beam signal to the integrator 301.

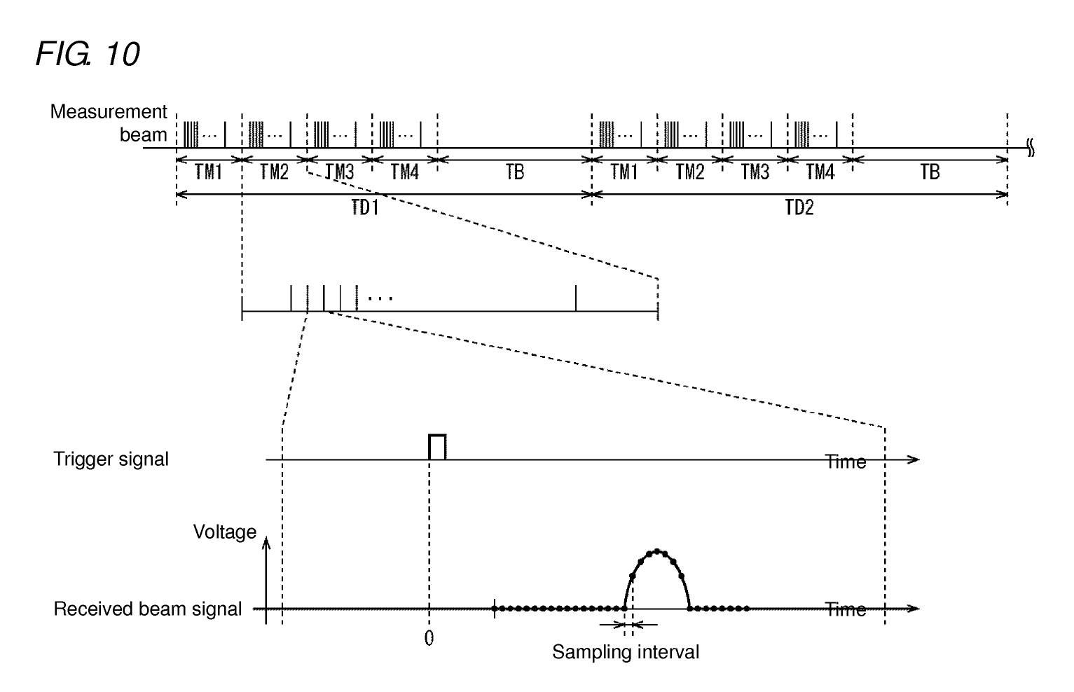

In addition, processing of sampling a received beam signal will be described in detail later with reference to FIG. 10.

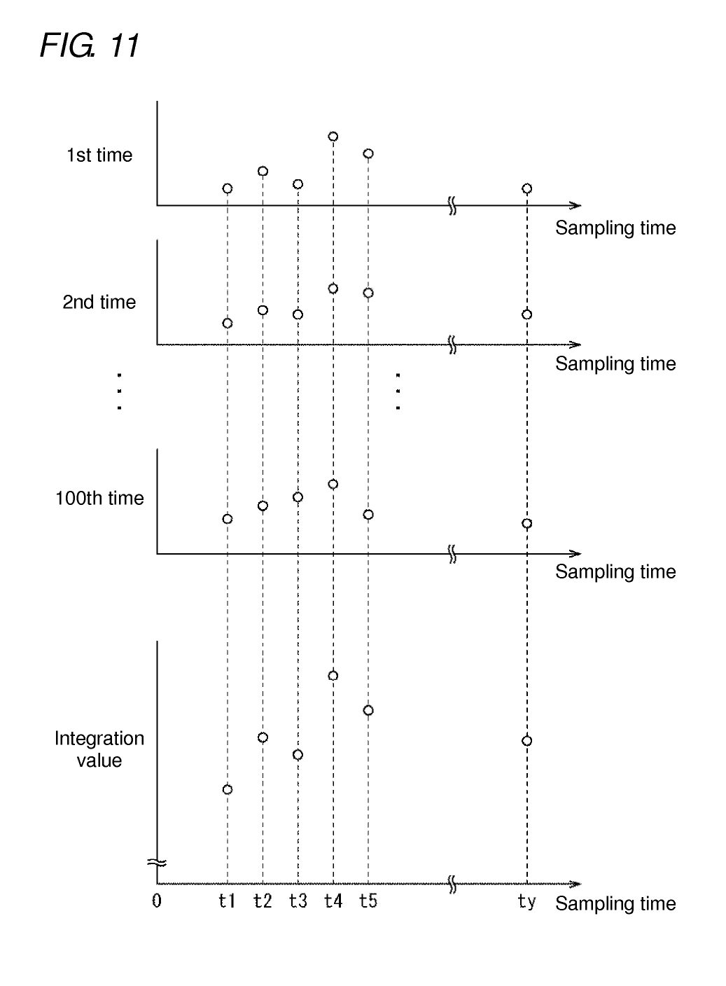

In step S5, the integrator 301 integrates previous received beam values and a current received beam value. By this means, as described later with reference to FIG. 11, received beam values of received beam signals from the same beam receiving element 202 at the same sampling time are integrated.

In step S6, the controller 21 determines whether or not received beam values are measured a predetermined number of times (e.g. 100 times). When it is determined that the received beam values are not yet measured a predetermined number of times, the processing returns to step S2.

Subsequently, until it is determined in step S6 that the received beam values are measured a predetermined number of times, processing in steps S2 to S6 is repeatedly executed. By this means, processing of projecting measurement beams in a measurement period of a predetermined duration described later and measuring received beam values of the selected beam receiving element 202 is repeated a predetermined number of times. Further, the measured received beam values are integrated.

Meanwhile, when it is determined in step S6 that the received beam values are measured a predetermined number of times, the processing moves to step S7.

In step S7, the controller 21 determines whether or not the measurement period repeats a predetermined number of times. When it is determined that a measurement period is not yet repeated a predetermined number of times, the processing returns to step S1.

Subsequently, until it is determined in step S7 that the measurement period is repeated a predetermined number of times, the processing in steps S1 to S7 is repeatedly executed. That is, the measurement period is repeated a predetermined number of times in a detection period of a predetermined duration described later. Further, the beam receiving element 202 which is a target to measure received beam values is selected per measurement period, and a detection area which is a reflected beam intensity measurement target is switched. In addition, the detection area to be switched herein means that one of detection areas of the horizontal direction beam receiver 51 set per horizontal direction and the sensing zones 52a-1 to 52a-3 of the vertical direction beam receiver 52 is switched.

Meanwhile, when it is determined in step S7 that the measurement period repeats a predetermined number of times, the processing moves to step S8.

Hereinafter, a specific example of the processing in steps S1 to S7 will be described with reference to FIGS. 10 to 12.

FIG. 10 is a timing chart illustrating the specific example of the processing of sampling a received beam signal, and the horizontal axis in a drawing of each stage in FIG. 10 indicates a time.

An uppermost stage in FIG. 10 indicates a light emission timing of a measurement beam. Detection periods TD1, TD2 and . . . are minimum units of a period for performing object detection processing, and the object detection processing is performed once in one detection period.

Further, each detection period includes measurement periods TM1 to TM4 of four cycles, and a pause period TB. The measurement period is a minimum unit at which the beam receiving element 202 whose received beam value is measured is switched. That is, while the beam receiving element 202 can be selected prior to each measurement period, the beam receiving element 202 cannot be changed in the measurement period. Hence, in one measurement period, the received beam values of the beam receiving elements 202 of the same type are measured. Consequently, it is possible to switch a detection area which is a reflected beam intensity measurement target in measurement period units.

The second stage in FIG. 10 is a view illustrating the enlarged measurement period TM2 of the detection period TD 1. As illustrated in FIG. 10, measurement beams are projected a predetermined number of times (e.g. 100 times) at predetermined intervals in the measurement period of one cycle.

The third stage in FIG. 10 illustrates a waveform of a trigger signal which defines a sampling timing of the ADC 264, and the fourth stage illustrates a sampling timing of a received beam signal in the ADC 264. In addition, the vertical axis at the fourth stage indicates a value (voltage) of a received beam signal, and each of a plurality of black circles on the received beam signal indicates a sampling point. Hence, a time between neighboring black circles is a sampling interval.

The controller 21 supplies the trigger signal to each ADC 264 a predetermined time after a measurement beam is projected. Each ADC 264 samples a received beam signal a predetermined number of times (e.g. 32 times) at a predetermined sampling frequency (e.g. several tens to several hundreds of MHz) a predetermined time after receiving an input of the trigger signal. That is, every time the measurement beam is projected, the received beam signal selected by the MUX 261 is sampled a predetermined number of times at predetermined sampling intervals.

When, for example, a sampling frequency of the ADC 264 is 100 MHz, the received beam signal is sampled at sampling intervals of 10 nano seconds. Hence, a received beam value is sampled at an interval of about 1.5 m in terms of a distance. That is, the intensity of a reflected beam from each spot at about 1.5 m intervals in the distance direction from the relevant vehicle in each detection area is measured.

Further, each ADC 264 supplies to the integrator 301 a digital received beam signal indicating a sampling value (received beam value) at each sampling time using a trigger signal as a reference (the time at which the trigger signal is inputted is 0).

As described above, every time a measurement beam is projected, a received beam signal of each beam receiving element 202 selected by the MUX 261 is sampled. By this means, the intensity of a reflected beam in the detection area of each selected beam receiving element 202 is detected in predetermined distance units.

Meanwhile, projecting measurement beams and measuring received beam values make a pause in the pause period TB. Further, the object detection processing is performed based on measurement results of received beam values in the measurement periods TM1 to TM4.

Next, a specific example of processing of integrating received beam values will be described with reference to FIG. 11. FIG. 11 illustrates an example of processing of integrating 100 received beam signals outputted from the given beam receiving element 202 when measurement beams are projected 100 times in a measurement period of one cycle. In addition, the horizontal axis in FIG. 11 indicates a time (sampling time) using a timing at which a trigger signal is inputted as a reference (time 0), and the vertical axis indicates a received beam value (sampling value).

As illustrated in FIG. 11, received beam signals of 1st to 100th measurement beams are sampled at sampling times t1 to ty, and received beam values at the same sampling time are integrated. For example, received beam values of the 1st to 100th measurement beams at the sampling time t1 are integrated. As described above, received beam values of the received beam signals which are sampled in the detection period and received from the same beam receiving element 202 are integrated at the same sampling time. Further, this integration value is used in subsequent processing.

In this regard, when received beam signals from a plurality of beam receiving elements 202 are added in the MUX 261, received beam values of the matching received beam signals between all beam receiving elements 202 are integrated. For example, received beam values of received beam signals which are obtained by adding received beam signals from the beam receiving elements 202-1 and 202-2 are integrated separately from received beam values of received beam signals from only one of the beam receiving element 202-1 and the beam receiving element 202-2. In other words, received beam values of received beam signals which are obtained by adding received beam signals from the beam receiving elements 202-1 and 202-2, and received beam values of received beam signals from only one of the beam receiving element 202-1 and the beam receiving element 202-2 are distinguished as received beam values obtained by sampling received beam signals of different types, and separately integrated.

According to this integration processing, even when a S/N ratio of a received beam signal of one measurement beam is low, a signal component is amplified and random noise is averaged and reduced by performing this integration processing. As a result, it is easy to demultiplex a signal component and a noise component from the received beam signal, and it is possible to substantially increase beam receiving sensitivity. Consequently, it is possible to improve detection precision of a distant object or an object of a low reflectance.

In addition, a set of measurement processing and integration processing executed a predetermined number of times (e.g. 100 times) in a measurement period of one cycle is referred to as a measurement/integration unit.

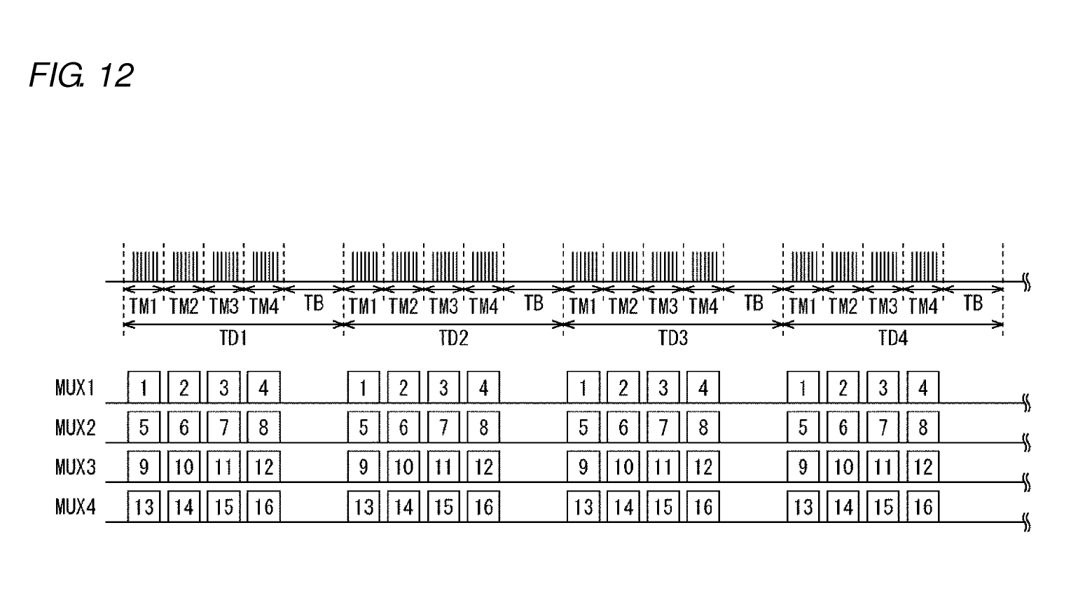

FIG. 12 illustrates a combination example of selection of the beam receiving element 202 of each MUX 261 in each measurement period. In addition, in FIG. 12, the MUXs 261-1 to 261-4 are abbreviated as MUXs 1 to 4. Further, numbers in square cells in FIG. 12 indicate numbers of the beam receiving elements 202 selected by the MUXs 261-1 to 261-4. That is, the beam receiving elements 202-1 to 202-16 are indicated by numbers 1 to 16, respectively.

For example, in the measurement period TM1, the MUXs 261-1 to 261-4 select the beam receiving elements 202-1, 202-5, 202-9 and 202-13, respectively, and measure a received beam value of each selected beam receiving element 202. In the measurement period TM2, the MUXs 261-1 to 261-4 select the beam receiving elements 202-2, 202-6, 202-10 and 202-14, respectively, and measure a received beam value of each selected beam receiving element 202. In the measurement period TM3, the MUXs 261-1 to 261-4 select the beam receiving elements 202-3, 202-7, 202-11 and 202-15, respectively, and measure a received beam value of each selected beam receiving element 202. In the measurement period TM4, the MUXs 261-1 to 261-4 select the beam receiving elements 202-4, 202-8, 202-12 and 202-16, respectively, and measure a received beam value of each selected beam receiving element 202.

Hence, in this example, received beam values of all beam receiving elements 202 are measured in one detection period. In other words, intensities of reflected beams from all detection areas in a monitoring area are measured in one detection period.

Back to FIG. 9, in step S8, the peak detector 311 detects a horizontal direction peak. More specifically, the integrator 301 supplies an integrated received beam value of each beam receiving element 202 of the horizontal direction beam receiver 51 in one detection period, to the peak detector 311. The peak detector 311 detects horizontal direction and time direction (distance direction) peaks of intensities of reflected beams in a detection period based on a distribution of the integrated received beam values of each beam receiving element 202 per sampling time.

More specifically, the peak detector 311 detects a sampling time at which the integrated received beam value comes to a peak per beam receiving element 202. Consequently, a spot at which the intensity of the reflected beam comes to a peak in the distance direction from the relevant vehicle is detected per detection area. In other words, in each detection area, a distance from the relevant vehicle to a spot at which the intensity of the reflected beam comes to a peak is detected.

Further, the peak detector 311 detects the beam receiving element 202 (detection area) whose integrated received beam value comes to a peak per sampling time. Consequently, the horizontal direction position (detection area) at which the intensity of the reflected beam comes to a peak per predetermined interval (e.g. per about 1.5 m) is detected in the distance direction from the relevant vehicle.

Further, the peak detector 311 supplies information indicating a detection result, to the object detector 312.

In addition, the peak detector 311 can adopt an arbitrary method as a peak detecting method.

In step S9, the peak detector 311 detects a vertical direction peak. More specifically, the integrator 301 supplies to the peak detector 311 an integrated received beam value of each beam receiving element 202 of the vertical direction beam receiver 52 in one detection period per sensing zone 52a. The peak detector 311 detects vertical direction and time direction (distance direction) peaks of intensities of reflected beams in a detection period based on a distribution of the integrated received beam values of each beam receiving element 202 per sampling time.

Further, the peak detector 311 specifies one of the sensing zones 52a-1 to 52a-3 for specifying the detection area to which the beam receiving element 202 whose integrated received beam value comes to a peak belongs per sampling time. Consequently, the vertical direction position (detection area) at which the intensity of the reflected beam comes to a peak is detected in the distance direction from the relevant vehicle per sensing zone 52a-1 to 52a-3 provided sandwiching the dead zones 52b-1 and 52b-2.

In step S10, the object detector 312 detects an object. More specifically, the object detector 312 detects whether or not there are other vehicles, walking persons and objects such as obstacles in a monitoring area, an object type, a direction, a distance or the like, based on detection results of horizontal direction and time direction distributions and peaks of intensities of reflected beams, and vertical direction and time direction distributions and peaks in the detection period. Further, the object detector 312 supplies information indicating a detection result, to the controller 21 and the notifier 303.

In addition, the object detector 312 can adopt an arbitrary method as the object detecting method.

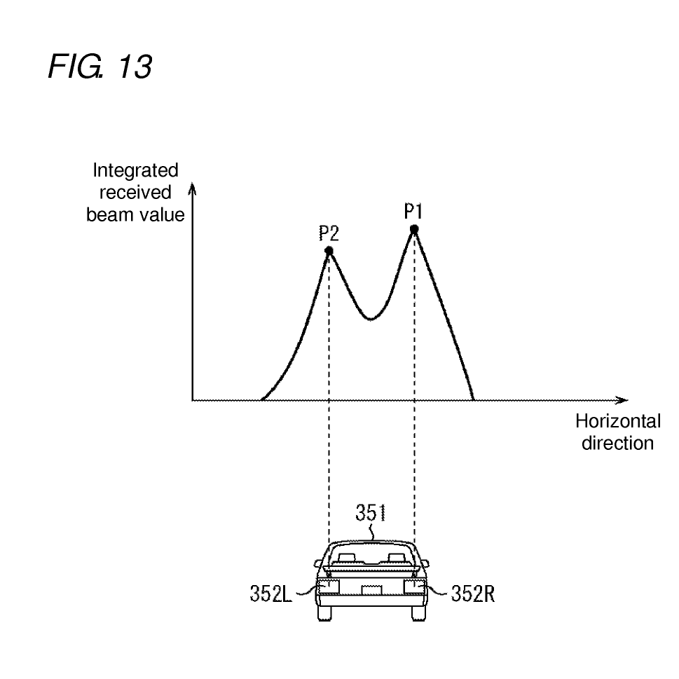

Hereinafter, an example of the object detecting method will be first described with reference to FIG. 13.

A graph in FIG. 13 illustrates a horizontal direction distribution of integrated received beam values near a sampling time at which a reflected beam returns from a vehicle 351 in the processing in step S8 when the vehicle 351 is driving ahead of the relevant vehicle. That is, this graph is a graph obtained by arranging integrated received beam values of the beam receiving elements 202 of the horizontal direction beam receiver 51 at the sampling time in a horizontal axis direction and in horizontal direction arrangement order of each beam receiving element 202.

A measurement beam is reflected by the vehicle 351 and received by the beam receiving element 202. However, there is a time difference between beam projection and beam reception. This time difference is proportional to a distance between the laser radar device 11 and the vehicle 351. Therefore, the reflected beam from the vehicle 351 is measured as a received beam value at a sampling timing (sampling time tn) matching the time difference. Hence, the integrated received beam value at the sampling time tn in particular among the integrated received beam values of the beam receiving elements 202 in a detection area including the vehicle 351 becomes high.

When there is the vehicle 351 ahead, a reflected beam reflected by the vehicle 351 is received by the beam receiving element 202. Therefore, the integrated received beam value of each beam receiving element 202 in the detection area including the vehicle 351 becomes high. Particularly, reflectances of left and right reflectors 352L and 352 R at the back of the vehicle 351 are high. Therefore, the integrated received beam value of each beam receiving element 202 in the detection area including the reflectors 352L and 352R becomes particularly high.

Hence, as illustrated by the graph in FIG. 13, two remarkable peaks P1 and P2 appear in the horizontal direction distribution of the integrated received beam values of the beam receiving elements 202 of the horizontal direction beam receiver 51. Further, reflected beams reflected from a vehicle body between the reflector 352L and the reflector 352R are also detected. Therefore, integrated received beam values between the peak P1 and the peak P2 also become high compared to those of the other areas. Thus, by detecting the two remarkable peaks in the horizontal direction distribution of the integrated received beam values at the same sampling time, it is possible to detect a vehicle ahead.

However, there is a concern that an object is erroneously detected only from information of this horizontal direction position and distance. That is, for example, it is assumed that there is an upward slope ahead of the relevant vehicle, and, on a road surface of this upward slope, there is a road stud in which a reflector called a cat's-eye (or a chatter-bar) is buried and which a vehicle has no problem to drive over. In this case, the laser radar device 11 is likely to erroneously detect the cat's-eye buried in the road surface as a leading vehicle in the monitoring area.

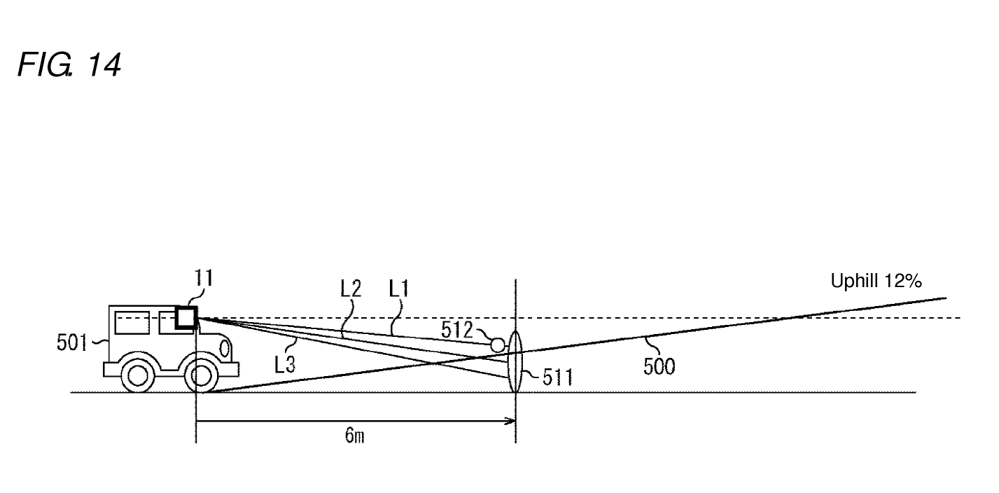

More specifically, as illustrated in FIG. 14, a cat's-eye 512 is provided on a slope 500 at which a measurement beam is an uphill degree 12%. When, at a position of 6 m of a distance from a relevant vehicle 501 in the front surface direction, a vertical direction height of a monitoring area to which the measurement beams are projected is 1 m, the height of the slope 500 is 75 cm at a position of 6 m of the distance from the relevant vehicle 501 in the front surface direction. Hence, as illustrated in FIG. 14, when the relevant vehicle 501 drives, the cat's-eye 512 is detected at the position of 6 m of the distance from the laser radar device 11 in the front surface direction. However, even though the cat's-eye 512 which is not likely to cause collision is detected, there is a concern that the cat's-eye 512 is erroneously detected as an object 511 which is likely to cause collision based only on information of the horizontal direction and the distance.

Hence, when detecting the horizontal direction position and distance of an object, the object detector 312 next detects a vertical direction distribution based on a distribution of integrated received beam values of the beam receiving elements 202 of the sensing zones 52a-1 to 52a-3 of the vertical direction beam receiver 52 which is calculated in the processing in step S9.

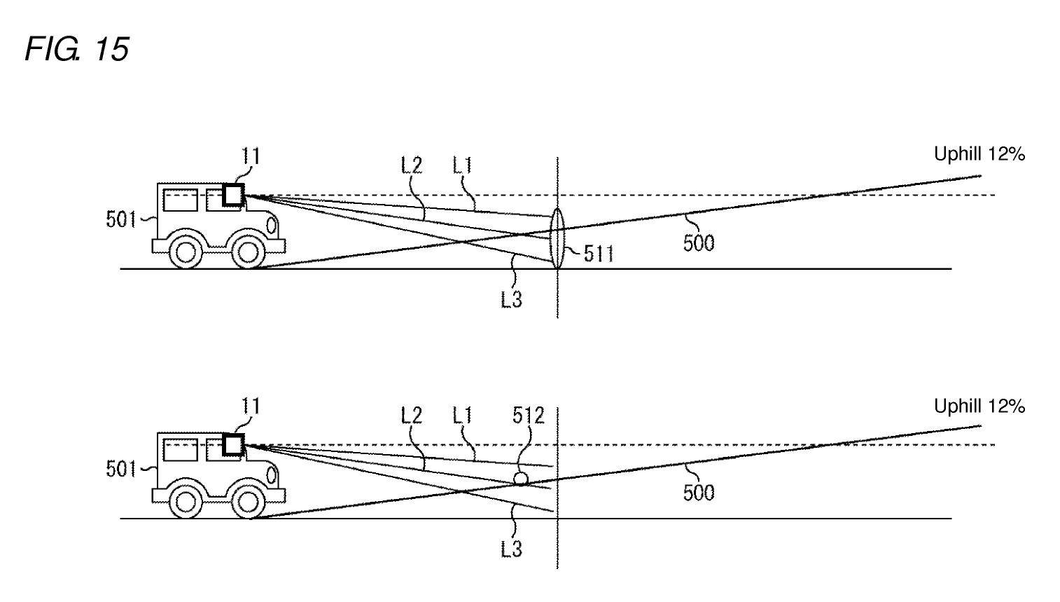

More specifically, as illustrated at the upper portion in FIG. 15, the object detector 312 receives at least two neighboring reflected beams of the reflected beams L1 to L3 from an upper stage, a middle stage and a lower stage of the object 511, based on detection results of the sensing zones 52a-1 to 52a-3. Further, the object detector 312 determines whether or not an object is the cat's-eye 512 installed in a road surface as illustrated at the lower portion in FIG. 15, i.e., the object is likely to cause collision based on whether or not distances are nearly the same.

That is, as illustrated at the lower portion in FIG. 15, when only the cat's-eye 512 is provided in the slope 500, only one of the sensing zones 52a-1 to 52a-3 in the vertical direction beam receiver 52 detects an object (detects an object based on the reflected beam L2 at the lower stage in FIG. 15). However, as illustrated at the upper portion in FIG. 15, the object 511 such as a person or a wall having a height continues in a vertical direction from a road surface. Hence, a plurality of continuous sensing zones 52a-1 to 52a-3 simultaneously receives reflected beams, and therefore detects the object 511 of different heights at the same distance.

Meanwhile, when there is a slope ahead of the relevant vehicle or the optical axis is shifted in the vertical direction with respect to the horizontal direction due to a motion of a suspension or a damper caused by an impact or vibration during driving, even if an object having a height is detected, the sensing zones 52a-1 to 52a-3 cannot simultaneously receive reflected beams at all times.

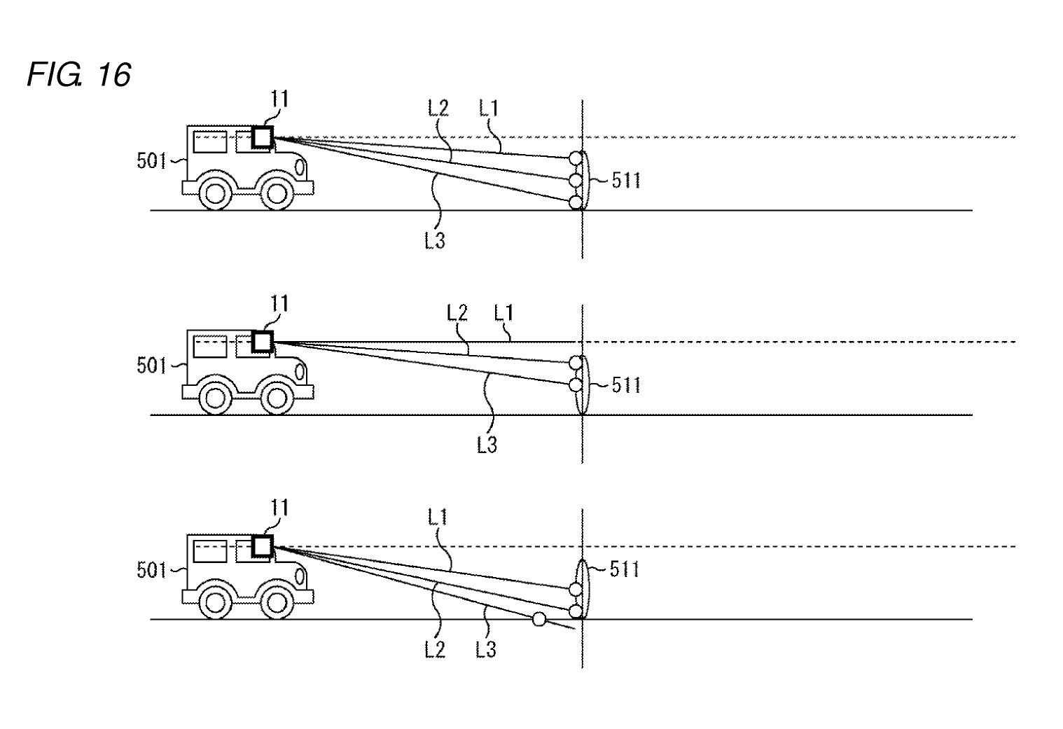

Hence, the object detector 312 recognizes that the object 511 having a height is detected, based on a distribution of integrated received beam values of the beam receiving elements 202 of the sensing zones 52a-1 to 52a-3 of the vertical direction beam receiver 52 when one of first to third conditions illustrated in FIG. 16 is satisfied.

That is, the first condition is that the optical axis is not shifted, and the sensing zones 52a-1 to 52a-3 receive the reflected beams L1 to L3, respectively as illustrated at the uppermost stage in FIG. 16. That is, when the sensing zones 52a-1 to 52a-3 receive the reflected beams L1 to L3, respectively and distances are nearly the same as a horizontal direction distance at which an object is detected, there are the objects of nearly the same distances at different heights, the object detector 312 recognizes that there is the object 511 having a height at this position.

Further, the second condition is that the optical axis is shifted in an upper direction and only the reflected beams L2 and L3 among the reflected beams L1 to L3 of the sensing zones 52a-1 to 52a-3 are received as illustrated at the middle stage in FIG. 16. That is, when the sensing zones 52a-2 and 52a-3 receive the reflected beams L2 and L3, respectively and distances are nearly the same as a horizontal direction distance at which an object is detected, there are the objects of nearly the same distances at different heights, the object detector 312 recognizes that there is the object 511 having a height at this position.

Further, the third condition is that the optical axis is shifted in a lower direction and only the reflected beams L1 and L2 among the reflected beams L1 to L3 of the sensing zones 52a-1 to 52a-3 are received as illustrated at the lower stage in FIG. 16. That is, when the sensing zones 52a-1 and 52a-2 receive the reflected beams L1 and L2, respectively and distances are nearly the same as a horizontal direction distance at which an object is detected, there are the objects of nearly the same distances at different heights, the object detector 312 recognizes that there is the object 511 having a height at this position.

When none of the above first to third conditions is satisfied, even if the horizontal direction beam receiver 51 detects an object, the object detector 312 recognizes that an object does not have a height like a cat's-eye, i.e., the object is not concerned to collide with the relevant vehicle.

Accordingly, to sum up these relationships, the object detector 312 recognizes that there is an object when two or more of the sensing zones 52a-1 to 52a-3 of the vertical direction beam receiver 52 which are continuous in the vertical direction detect reflected beams at nearly the same distances as a horizontal distance at which the object is detected by the horizontal direction beam receiver 51. Further, the object detector 312 outputs the horizontal direction position and distance as a detection result.

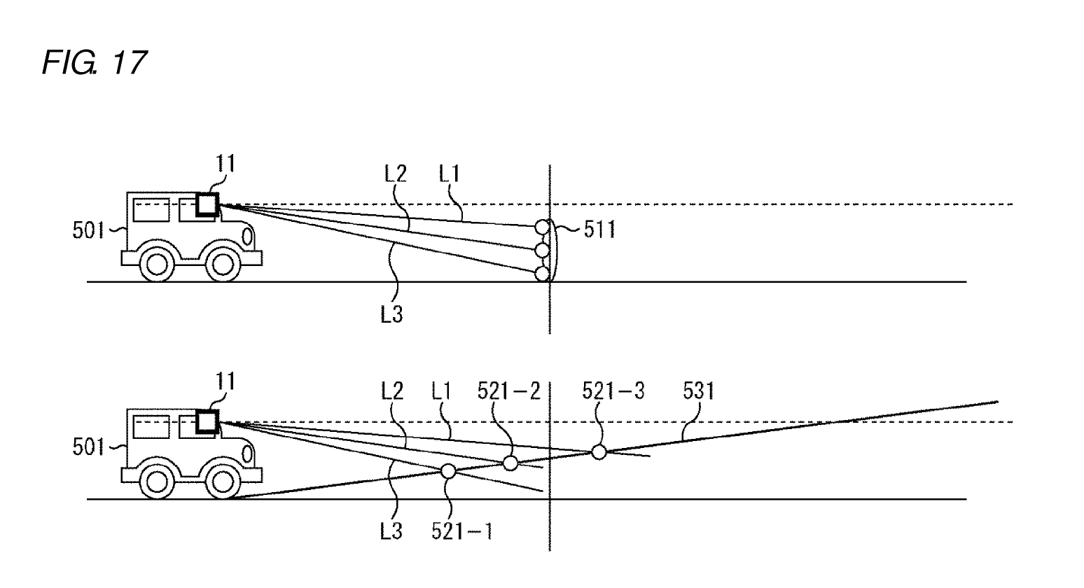

That is, compared to a state where the first condition is satisfied as illustrated at the upper stage in FIG. 17, even when the sensing zones 52a-1 to 52a-3 receive the reflected beams L1 to L3, respectively, as illustrated at a lower stage in FIG. 17, if detection distances are different, it is recognized that objects 521-1 to 521-3 without heights are detected, based on the detection results.

Hence, in this case, the object detector 312 recognizes that an object is not concerned to collide with the relevant vehicle even when the horizontal direction beam receiver 51 detects the object in the horizontal direction, and does not output information of the horizontal direction and the distance at which the object is detected.

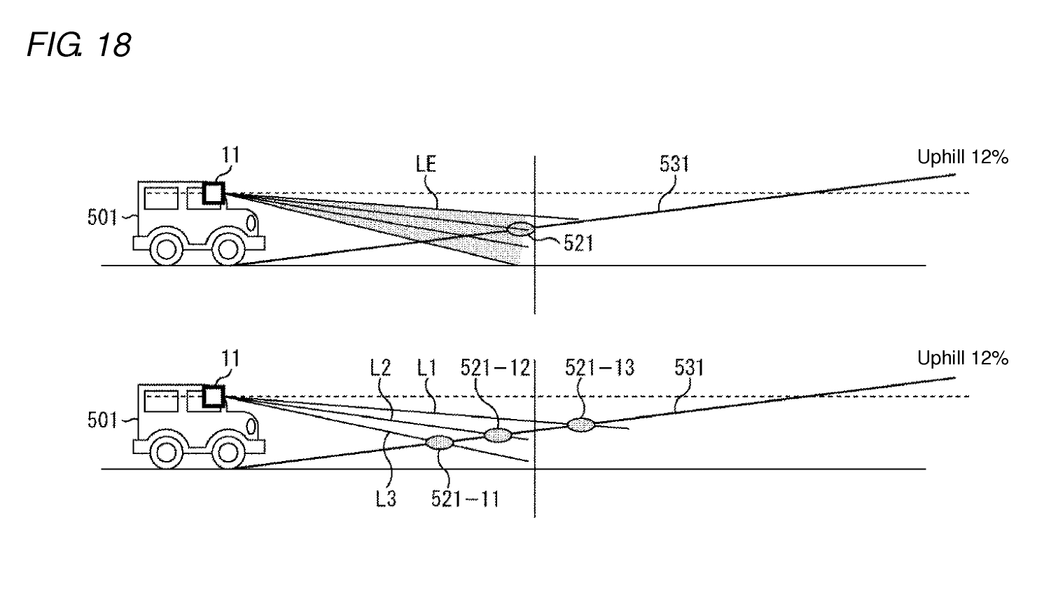

In addition, the dead zone 52b of the vertical direction beam receiver 52 sets vertical direction resolutions. That is, as illustrated at an upper stage in FIG. 18, when the dead zone 52b is not provided, the sensing zones 52a-1 to 52a-3 are continuously adjacent to each other. Therefore, when both of the sensing zones 52a-1 and 52a-2 receive beams from neighboring cat's-eyes 521, the same distances are detected in two detection areas. Therefore, the cat's-eyes are erroneously detected as obstacles having heights.

By contrast with this, as illustrated at the lower portion in FIG. 18, the dead zones 52b-1 and 52b-2 are provided, so that beam reception areas of the sensing zones 52a-1 to 52a-3 are divided into three areas. Further, even when an object such as a cat's-eye without a height is detected, the different sensing zones 52a-1 to 52a-3 receive the reflected beams L1 to L3 from different distances. Consequently, it is possible to recognize that distances to objects are different and to recognize that objects without heights are detected. In addition, widths of the dead zones 52b-1 and 52b-2 need to be set to, for example, 6 m of a detection distance ahead of the vehicle, and have dead zone widths which are larger than reflected beams reflected from a cat's-eye which is assumed to exist therein and formed on the vertical direction beam receiver 52 by the beam receiving optical system 201-2.

As a result, when at least two or more continuous sensing zones 52a-1 to 52a-3 which monitor different vertical directions and between which dead zones are provided do not detect an object at the same distances, it is possible to recognize that an object having a height is not detected. That is, as illustrated at the lower portion in FIG. 18, even when the sensing zones 52a-1 to 52a-3 receive the reflected beams L1 to L3 from the different objects 521-1 to 521-3, if different distances are measured, it is possible to recognize that an object having a height is not detected.

Back to explanation of the flowchart in FIG. 9, in step S11, the notifier 303 notifies to the outside an object detection result when necessary. For example, the notifier 303 supplies the object detection result to the vehicle control device 12 on a regular basis irrespectively of whether or not there is an object. Alternatively, for example, the notifier 303 supplies the object detection result to the vehicle control device 12 when there is a risk that a vehicle collides against an object ahead.

In step S12, the controller 21 stands by for a predetermined period of time. That is, the controller 21 stands by without projecting measurement beams until the pause period TB in FIG. 10 ends.

Subsequently, the processing returns to step S1, and processing in step S1 to S12 is repeatedly executed. That is, processing of detecting an object based on integrated received beam values is repeated per detection period.

As described above, it is recognized that there is an object having a height (an object which is likely to cause collision) when two or more of the sensing zones 52a-1 to 52a-3 of the vertical direction beam receiver 52 which are continuous in the vertical direction detect reflected beams at nearly the same distances as a horizontal distance at which the object is detected by the horizontal direction beam receiver 51, and measure the same distances. Further, the horizontal direction position and distance in this case are outputted as a detection result.

When an object is detected in a monitoring area as a result, it is possible to output information of the horizontal direction of the detected object and the distance of the object if the object is concerned to collide with the relevant vehicle depending on whether or not the object has a vertical direction height. Further, it is possible to prevent an object which is not likely to cause collision, from being erroneously detected as an object which is likely to cause collision.

In addition, an example where, by repeating measuring a received beam value of each beam receiving element 202 in predetermined order, a measurement period is allocated once to each beam receiving element 202 in one detection period has been described above. In other words, an example where the measurement/integration unit is performed once with respect to each beam receiving element 202 in one detection period has been described above. In this case, it is possible to widely and uniformly monitor the entire monitoring area.

Meanwhile, as described above, each MUX 261 can freely select a received beam signal, and can freely set a combination of the beam receiving elements 202 which measure received beam values. That is, it is possible to perform the measurement/integration unit with respect to each beam receiving element 202 four times at maximum in one detection period, or not to perform the measurement/integration unit even once.

Consequently, it is possible to adjust the frequency to perform the measurement/integration unit with respect to each beam receiving element 202 when it is necessary to monitor each detection area. By, for example, increasing the frequency to execute the measurement/integration unit with respect to a detection area which is highly necessary to be monitored such as an area in which an object is detected, an area in which an object is highly likely to be present and an area in which the degree of risk is high, and increasing the number of times of integration of received beam values, it is possible to intensively monitor the detection area. By contrast with this, by, for example, decreasing the frequency to execute the measurement/integration unit with respect to a detection area which is less necessary to be monitored such as an area in which an object is not yet detected, an area in which an object is highly likely to be absent and an area in which the degree of risk is low, and decreasing the number of times of integration of received beam values, it is possible to intermittently monitor the detection area.

### 2. Modified Example

An example where a horizontal direction beam receiver 51 and a vertical direction beam receiver 52 which form a beam receiver 23 are provided in the arrangement illustrated in FIG. 2 has been described above. The other arrangement may be applicable as long as respective functions of the horizontal direction beam receiver 51 and the vertical direction beam receiver 52 can be realized.

As illustrated in a laser radar device 11A at an uppermost stage in FIG. 19, a horizontal direction arrangement of sensing zones 52a-1 to 52a-3 may be changed such that the sensing zones 52a-1 and 52a-3 are located above and below the horizontal direction beam receiver 51 and the sensing zone 52a-2 is located at a neighboring position without changing a vertical direction positional relationship between the sensing zones 52a-1 to 52a-3. Hence, although not illustrated, the sensing zone 52a-2 may be located not only on the right side of the horizontal direction beam receiver 51 but also on the left side.

Further, as illustrated in a laser radar device 11B at a second stage in FIG. 19, only the sensing zones 52a-1 and 52a-3 may be located above and below the horizontal direction beam receiver 51. In such a case, a detection result of the horizontal direction beam receiver 51 is regarded as a result of the sensing zone 52a-2 to perform processing. Hence, when one of the sensing zones 52a-1 and 52a-3 detects an object at the same distance as a distance at which the horizontal direction beam receiver 51 detects that there is the object, it is recognized that the object is detected.

Further, as illustrated in a laser radar device 11C at a third stage in FIG. 19, the sensing zones 52a-1 and 52a-2 may be located above and below the horizontal direction beam receiver 51, a dead zone 52b may be provided below the sensing zones 52a-1 and 52a-2 and the sensing zone 52a-3 may be provided below the dead zone 52b.

Further, as illustrated in a laser radar device 11D at the fourth stage in FIG. 19, a beam receiver 23-1 formed by the horizontal direction beam receiver 51 and a beam receiver 23-2 formed by a vertical direction beam receiver 52 may be located at left and right positions sandwiching a projector 22. Naturally, a positional relationship between the beam receivers 23-1 and 23-2 illustrated at the fourth stage in FIG. 19 may allow an arrangement to be switched between the left and the right.

Further, as illustrated in a laser radar device 11E at the fifth stage in FIG. 19, a beam receiver 23-11 provided with the sensing zones 52a-1 and 52a-3 above and below the horizontal direction beam receiver 51, and a beam receiver 23-12 formed by the sensing zone 52a-2 may be located at left and right positions sandwiching the projector 22. Naturally, a positional relationship between the beam receivers 23-11 and 23-12 illustrated at the fifth stage in FIG. 19 may allow an arrangement to be switched between the left and the right.

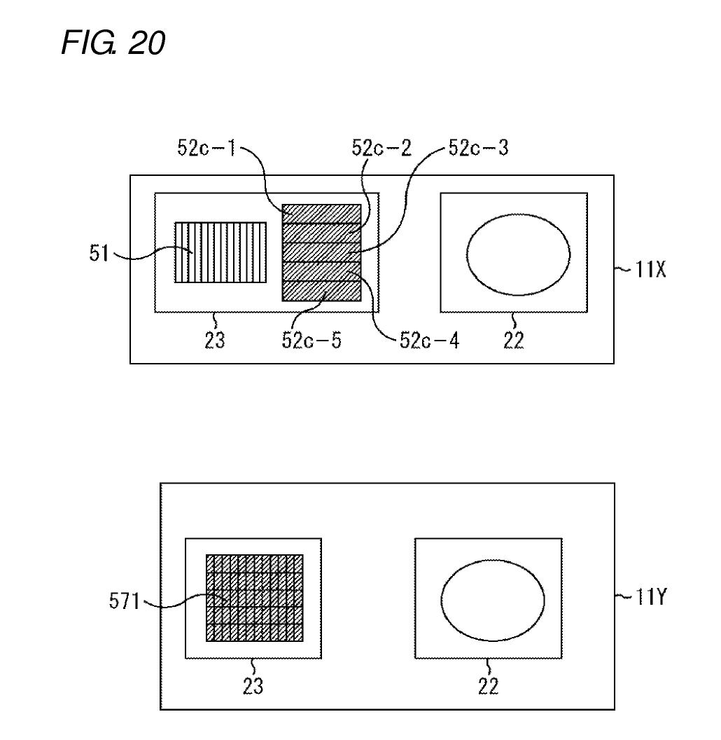

Further, an example where dead zones 52b-1 and 52b-2 are located between the sensing zones 52a-1 to 52a-3 in the vertical direction beam receiver 52 has been described above. As illustrated in, for example, a laser radar device 11X at the uppermost stage in FIG. 20, all zones may be sensing zones 52c-1 to 52c-5. In addition, sensing zones 52c are the same as sensing zones 52a.

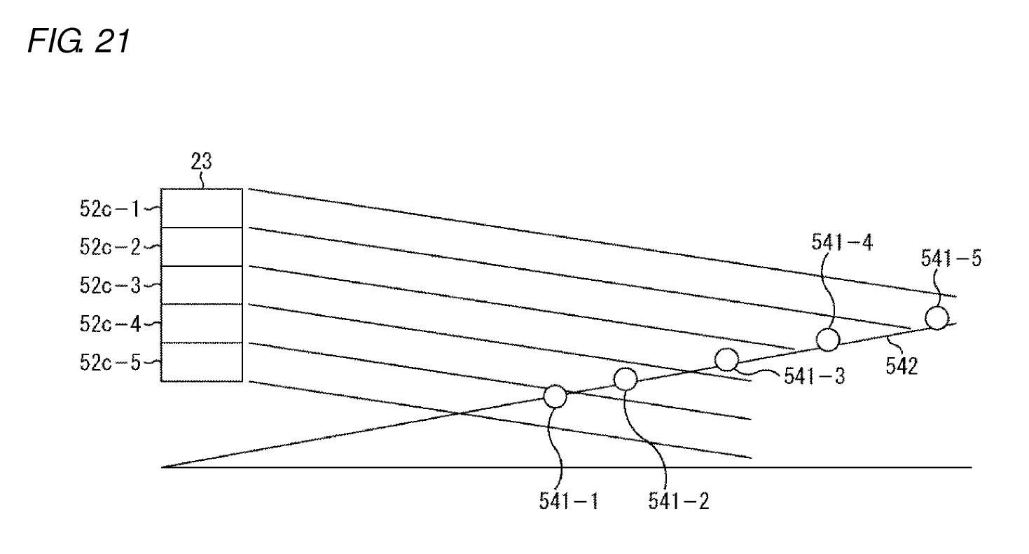

In this regard, as illustrated in FIG. 21, the sensing zones 52c-1 to 52c-5 can receive reflected beams, respectively, and, therefore, when there is a slope 542 in a front surface direction which is a driving direction of a relevant vehicle, distances to positions 541-1 to 541-5 on the slope 542 are detected.

As described above, the reason why the dead zones 52b are provided is to detect distances of positions which are discretely set in the vertical direction of a monitoring area, and to recognize that an object having a height is likely to collide with the relevant vehicle when the detected distances are the same.

Hence, even when the dead zones 52b are not provided, it is necessary to cause part of the sensing zones 52c to function as the dead zones 52b. Therefore, when there is even one pair of sensing zones 52c which are positioned sandwiching the sensing zone 52c of one row in the vertical direction with respect to the sensing zone 52c which detects a distance, and which detect the same distances, it is recognized that there is an object having a height.

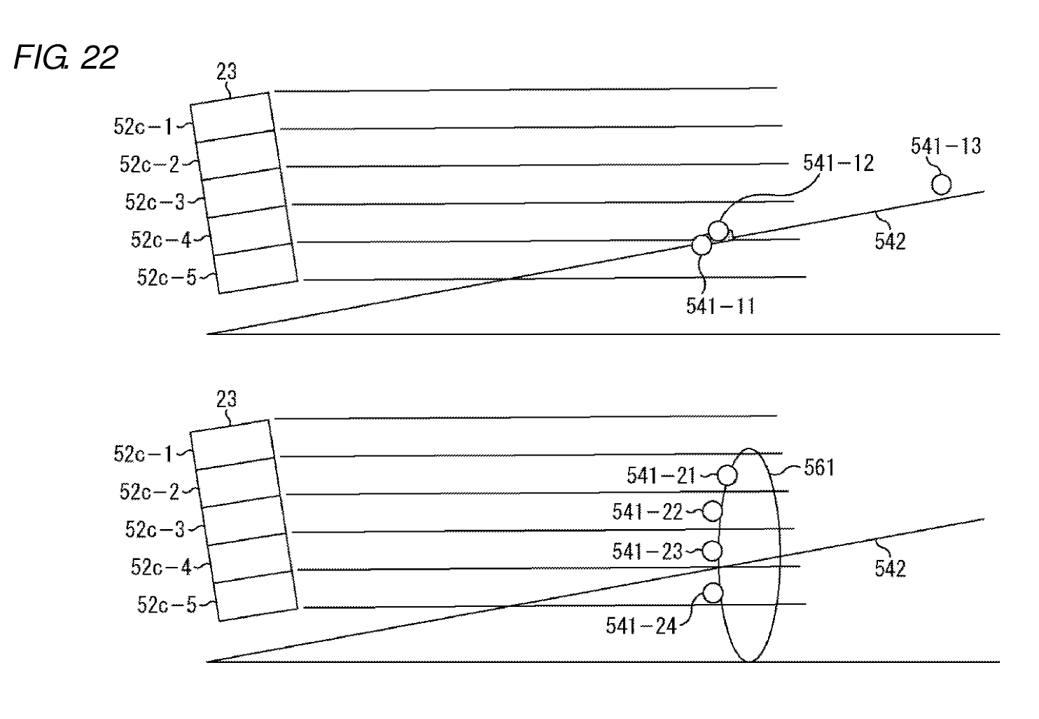

That is, as illustrated at, for example, the upper stage in FIG. 22, when the sensing zones 52c-3 to 52c-5 detect positions 541-11 to 541-13 whose distances on the slope 542 are not the same, and the other sensing zones 52c-1 and 52c-2 do not detect an object, the following determination is made.

That is, the sensing zone 52c-5 among the sensing zones 52c-1 and 52c-5 at positions sandwiching the sensing zones 52c-2 and 52c-4 of neighboring rows with respect to the sensing zone 52c-3 detects an object. However, distances to the positions 541-11 and 541-13 are not the same, and therefore it is recognized that there is not the sensing zones 52c which detect objects of the same distances.

Further, the sensing zone 52c-2 positioned to sandwich the sensing zone 52c-3 of one row with respect to the sensing zone 52c-4 does not detect an object, and therefore there are not the sensing zones 52c which detect objects of the same distances as a distance to an object detected by the sensing zone 52c-4.

As a result, in case of the upper stage in FIG. 22, there is not even one pair of sensing zones 52c which are positioned to sandwich the sensing zone 52c of one row in the vertical direction and which detects the same distance, it is recognized that an object having a height is not detected.

Meanwhile, as illustrated at the lower stage in FIG. 22, when the sensing zones 52c-2 to 52c-5 detect positions 541-21 to 541-24 of nearly the same distances, the sensing zone 52c-2 and the sensing zone 52c-4 which is positioned to sandwich the sensing zone 52c-3 detect objects at the positions 541-21 and 541-23 of nearly the same distances. Further, the sensing zones 52c-3 and 52-c5 having the same relationship detect objects at same positions 541-22 and 541-24 of nearly the same distances.

As a result, in case of the lower stage in FIG. 22, there are the sensing zones 52c which are positioned to sandwich the sensing zone 52c of one row in the vertical direction of one of the sensing zones 52c, and which detect the same distances, it is recognized that an object having a height is detected.

Further, as illustrated in a laser radar device 11Y at the lower stage in FIG. 20, by two-dimensionally locating beam receiving elements 202, the beam receiver 23 formed by a two-dimensional beam receiver 571 which has functions of both of the horizontal direction beam receiver 51 and the vertical direction beam receiver 52 may be provided. In this regard, an operation of the two-dimensional beam receiver 571 only realizes the functions of the horizontal direction beam receiver 51 and the vertical direction beam receiver 52, respectively likewise, and therefore will not be described.

A case where vertical direction sensing zones are three areas has been described above. However, the number of sensing zones may be three or more areas. Further, intervals between sensing zones and dead zones may be equal intervals or unequal intervals as long as sensing zones are not continuously formed, i.e., sensing zones are discretely formed to some extent.

Further, a case where, when two or more sensing zones formed to sandwich a dead zone continuously detect objects, an object having a height is detected has been described above. The number of sensing zones which can determine objects having a height may be increased according to the number of areas set as sensing zones. That is, when sensing zones of 10 areas are set sandwiching predetermined dead zones in the vertical direction, and, for example, only when sensing areas of five or more continuous areas sandwiching dead zones detect objects of the same distances, it may be recognized that an object having a height is detected.

Further, the present invention is also applicable to a laser radar device which is used for other uses other than a vehicle.

### Configuration Example of Computer

In addition, the above series of processing can also be executed by hardware or can also be executed by software. When the series of processing is executed by software, a program which configures this software is installed in a computer. In this regard, the computer includes a computer implemented in dedicated hardware, and, for example, a general-use personal computer which can execute various types of functions by installing various programs therein.

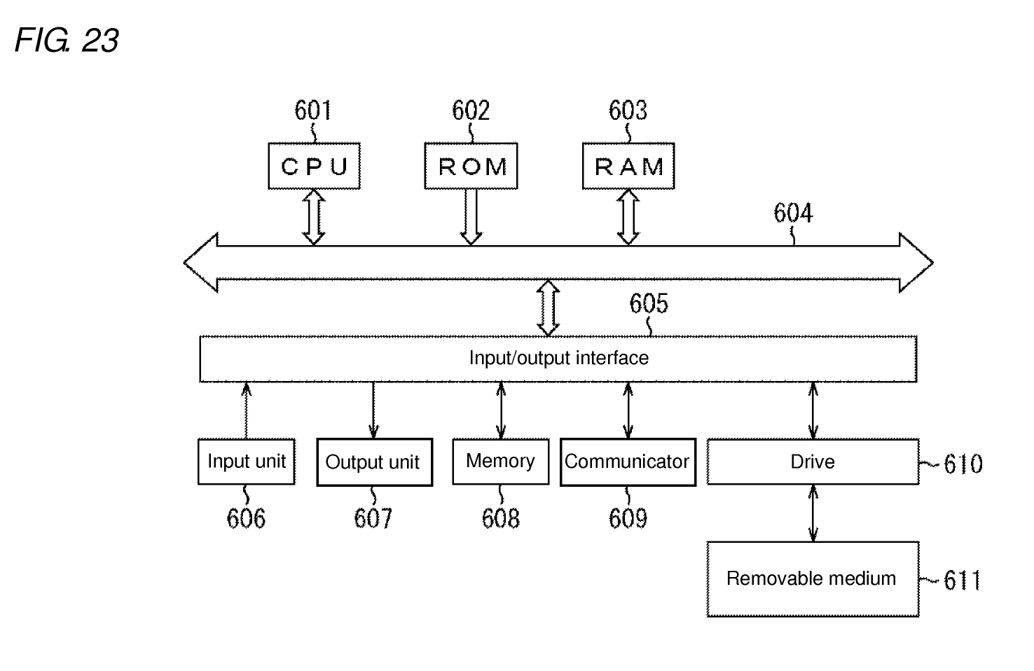

FIG. 23 is a block diagram illustrating a configuration example of hardware of a computer which executes the above series of processing according to a program.

In the computer, a CPU (Central Processing Unit) 601, a ROM (Read Only Memory) 602 and a RAM (Random Access Memory) 603 are connected with each other through a bus 604.

The bus 604 is connected with an input/output interface 605. The input/output interface 605 is connected with an input unit 606, an output unit 607, a memory 608, a communicator 609 and a drive 610.

The input unit 606 includes a keyboard, a mouse, a microphone and the like. The output unit 607 includes a display, speakers and the like. The memory 608 includes a hard disk, a non-volatile memory and the like. The communicator 609 includes a network interface. The drive 610 drives a removable medium 611 such as a magnetic disk, an optical disk, an optomagnetic disk or a semiconductor memory.

In the computer configured as described above, the CPU 601 performs the above series of processing by, for example, loading the program stored in the memory 608 to the RAM 603 through the input/output interface 605 and the bus 604, and executing the program.

The programs executed by the computer (CPU 601) can be provided by, for example, being recorded in the removable medium 611 as a package medium. Further, the programs can be provided through wired or wireless transmission media such as local area networks, the Internet and digital satellite broadcast.

In the computer, the programs can be installed to the memory 608 through the input/output interface 605 by attaching the removable medium 611 to the drive 610. Further, the programs can be installed to the memory 608 by being received at the communicator 609 through the wired or the wireless transmission media. In addition, the programs can be installed in advance in the ROM 602 or the memory 608.

In addition, the programs executed by the computer may be programs whose processing is executed in a time sequence according to the order described in this description or may be the programs whose processing is performed in parallel or at a necessary timing at which, for example, the programs are invoked.

While the invention has been described with reference to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A laser radar device comprising:
a projector configured to project a laser beam to a predetermined monitoring area;
a vertical direction beam receiver configured to receive reflected beam of the laser beam, the vertical direction beam receiver including predetermined numbers of dead zones and sensing zones disposed alternately in a vertical direction, and including in the vertical direction a plurality of resolutions;
a peak detector configured to detect a peak of a received beam level of each of the reflected beams received by the sensing zones; and
an object detector configured to calculate a distance to an object per sensing zone using the peak,
wherein the object detector recognizes that the object including a predetermined height is detected when continuously recognizing the distance calculated per sensing zone as the same distance for a predetermined number of times or more.

2. The laser radar device according to claim 1, wherein the dead zones and the sensing zones are located at the same positions or different positions in a horizontal direction.

3. The laser radar device according to claim 1, wherein the dead zones are configured as the sensing zones, and function as the dead zones by causing the sensing zones not to function.

4. An object detecting method comprising the steps of:
projecting a laser beam to a predetermined monitoring area;
receiving reflected beam of the laser beam at a vertical direction beam receiver including predetermined numbers of dead zones and sensing zones disposed alternately in a vertical direction and including a plurality of resolutions in the vertical direction;
detecting a peak of a received beam level of each of the reflected beams received by the sensing zones; and
calculating a distance to an object per sensing zone using the peak,
wherein it is recognized that the object including a predetermined height is detected when the distance calculated per sensing zone is continuously recognized as the same distance for a predetermined number of times or more.
